(19) United States
(12) Patent Application Publication
(10) Pub. No.: US 2026/0131283 A1
(43) Pub. Date: May 14, 2026

(54) CRYSTALLIZER DEVICES AND RELATED SYSTEMS AND METHODS FOR DIRECT AIR CAPTURE OF CO2

(71) Applicants: David Sinton, Toronto (CA); Dongha Kim, Toronto (CA); Shijie Liu, Toronto (CA)

(72) Inventors: David Sinton, Toronto (CA); Dongha Kim, Toronto (CA); Shijie Liu, Toronto (CA)

(21) Appl. No.: 19/271,303

(22) Filed: Jul. 16, 2025

Related U.S. Application Data
(60) Provisional application No. 63/671,978, filed on Jul. 16, 2024.

(51) Int. Cl. B01D 53/78; B01D 9/00; B01D 53/62; B01D 53/96; C01D 7/07; C25B 1/16

(52) U.S. Cl. CPC B01D 53/78; B01D 9/0027; B01D 9/0045; B01D 53/62; B01D 53/965; C01D 7/07; C25B 1/16; B01D 2009/0086; B01D 2251/306; B01D 2251/604; B01D 2257/504

(57) ABSTRACT

Crystallizer devices and methods of direct air capture of carbon dioxide are described herein. The methods include providing one or more polymeric strands in contact with an alkaline capture solution. Each of the polymeric strands is comprised of a plurality of polymeric fibers that combine to form an outer surface of the polymeric strand. The outer surface of the strand forms a crystallizing surface. The alkaline capture solution travels by way of capillary force from the outer surface of the strand inwardly through intra-strand pores and from a first end of the strand in a direction towards a second end of the strand through intra-strand pores. The methods also include, as the alkaline solution travels towards the second end, contacting the one or more polymeric strands with ambient air such that KOH within the alkaline solution reacts with CO₂ to form K₂CO₃ precipitate at the crystallizing surface.

### CROSS-REFERENCE

The present application claims the benefit of U.S. provisional patent application No. 63/671,978 entitled “CRYSTALLIZER DEVICES AND RELATED SYSTEMS AND METHODS FOR DIRECTAIR CAPTURE OF CO_{2”} filed on Jul. 16, 2024, the entire contents of which are incorporated by reference herein.

### TECHNICAL FIELD

The present application relates generally to direct air capture of carbon dioxide (CO₂) and, more generally to crystallizer devices and methods for direct air capture of CO₂.

### BACKGROUND

Direct air capture (DAC) provides a means to lessen atmospheric CO₂ levels and mitigate persistent emissions¹⁻³. To extract CO₂ from the atmospheric air, current DAC technologies employ industrial air contactors that direct air, propelled by fans, over porous packing materials wet by liquid sorbents: sorbent+CO₂→sorbent-CO₂ (sorbent chemical loop in FIG. 1A). Additionally, another chemical loop, employing solid Ca salts⁴ or solid organic guanidine compounds^{5,6}, operates simultaneously to separate CO₂ from the sorbent-CO₂ into solid form and regenerate the sorbent, thus maintaining a high [sorbent]/[sorbent-CO₂] ratio. These coupled chemical loops are needed to produce a concentrated solid form of carbon and ensure the capture reaction proceeds towards the adduct (sorbent+CO₂↔sorbent-CO₂)—otherwise, the capture rate decreases over time (FIG. 1B).

However, the need for these chemical loops increases cost, and their coupled operation requires balanced mass and energy flows throughout the entire system⁴, further increasing the complexity and inefficiency of DAC^{4,7-10}. Previous studies sought to avoid using the additional solid chemical loop by directly precipitating the sorbent-CO₂ into solid form¹¹⁻¹³. LiOH has been used as a sorbent to precipitate Li₂CO₃ as LiOH captured CO₂, levering the low solubility limit of Li₂CO₃^{11,12}. The separation of solid Li₂CO₃ salts from the capture solution and their subsequent post-treatment for CO₂ separation and sorbent regeneration allowed for the completion of a DAC cycle without the solid chemical loop. Similar approaches have used amino acid salts to precipitate their carbon-captured species^{13,14}. However, these methods necessitate additional filtration steps to collect the precipitates from liquid and suffer costs associated with the use of Li or organic amines which degrade in air. Solid precipitates can also present practical challenges for liquid-air contactors, to the extent that contactors are designed to avoid solidification^{13,15}.

Accordingly, there is a need for new systems and methods for direct air capture of carbon dioxide.

### SUMMARY

The following summary is intended to introduce the reader to various aspects of the applicant's teaching, but not to define any invention.

In accordance with a broad aspect, a method of forming a precipitate is described herein. The method includes providing one or more polymeric strands in contact with an alkaline capture solution, each of the polymeric strands comprised of a plurality of polymeric fibers that combine to form an outer surface of the polymeric strand, the outer surface of the strand forming a crystallizing surface, the alkaline capture solution travelling by way of capillary force from the outer surface of the strand inwardly and from a first end of the strand in a direction towards a second end of the strand, water within the alkaline solution evaporating from the alkaline solution as the alkaline solution travels from the first end towards the second end; and as the alkaline solution travels towards the second end, contacting the one or more polymeric strands with ambient air, KOH within the alkaline solution reacting with CO₂ in the ambient air at the crystallizing surface to form K₂CO₃ precipitate at the crystallizing surface.

In at least one embodiment, the one or more polymeric strands are formed of a polymer selected from the group comprising: polypropylene, polyethylene, polyvinyl chloride, polystyrene, polyethylene terephthalate, polyamide, polycarbonate, polyurethane, acrylonitrile butadiene styrene, polymethyl methacrylate, polyoxymethylene, and polybutylene terephthalate.

In at least one embodiment, the one or more polymeric strands comprise polypropylene.

In at least one embodiment, the polymeric fibers are parallel with each other within the strand.

In at least one embodiment, providing one or more polymeric strands includes providing one or more polymeric cords, each polymeric cord comprising two or more polymeric strands.

In at least one embodiment, the one or more polymeric strands each of have an ascending portion and a descending portion, the alkaline capture solution travelling upwardly along the ascending portion by way of the capillary force and downwardly along the descending portion by gravity.

In at least one embodiment, the K₂CO₃ precipitate forms at the crystallizing surface along the descending portion.

In at least one embodiment, the water within the alkaline capture solution evaporating from the strand occurs as the alkaline capture solution travels downwardly along the descending portion.

In at least one embodiment, the polypropylene is chemically modified by at least one of hydrophilization, corona discharge, or plasma treatment.

In accordance with another broad aspect, a method of direct air capture of carbon dioxide is described herein. The method includes providing one or more polymeric strands in contact with an alkaline capture solution, each of the polymeric strands comprised of a plurality of polymeric fibers that combine to form an outer surface of the polymeric strand, the outer surface of the strand forming a crystallizing surface; positioning at least a portion of the strands into an alkaline capture solution, the alkaline capture solution travelling by way of capillary force from the outer surface of the strand inwardly and from a first end of the strand in a direction towards a second end of the strand, water within the alkaline solution evaporating from the alkaline solution as the alkaline solution travels from the first end towards the second end; as the alkaline solution travels towards the second end, contacting the one or more polymeric strands with ambient air, KOH within the alkaline solution reacting with CO₂ in the ambient air at the crystallizing surface to form K₂CO₃ precipitate at the crystallizing surface; flooding the strands with a flooding fluid to wash the K₂CO₃ precipitate from the crystallizing surface; collecting the washed K₂CO₃ precipitate; and introducing the washed K₂CO₃ precipitate into an electrochemical cell to produce carbon dioxide and KOH.

In accordance with another broad aspect, a crystallizer device is described herein. The device includes a solution platform housing an alkaline capture solution; and a plurality of polymeric strands in contact with the alkaline capture solution, each of the polymeric strands having: a plurality of polymeric fibers that combine to form an outer surface of the polymeric strand, the outer surface of the strand forming a crystallizing surface, the alkaline capture solution travelling by way of capillary action from the outer surface of the strand inwardly and from a first end of the strand in a direction towards a second end of the strand, water within the alkaline solution evaporating from the alkaline solution as the alkaline solution travels from the first end towards the second end.

In at least one embodiment, the one or more polymeric strands are formed of a polymer selected from the group comprising: polypropylene, polyethylene, polyvinyl chloride, polystyrene, polyethylene terephthalate, polyamide, polycarbonate, polyurethane, acrylonitrile butadiene styrene, polymethyl methacrylate, polyoxymethylene, and polybutylene terephthalate.

In at least one embodiment, the one or more polymeric strands comprise polypropylene.

In at least one embodiment, the polymeric fibers are parallel with each other within the strand.

In at least one embodiment, providing one or more polymeric strands includes providing one or more polymeric cords, each polymeric cord comprising two or more polymeric strands woven together.

In at least one embodiment, the one or more polymeric strands each of an ascending portion and a descending portion, the alkaline capture solution travelling upwardly along the ascending portion by way of capillary action and downwardly along the descending portion by gravity.

In at least one embodiment, the K₂CO₃ precipitate forms at the crystallizing surface along the descending portion.

In at least one embodiment, the water within the alkaline capture solution evaporating from the strand occurs as the alkaline capture solution travels downwardly along the descending portion.

In at least one embodiment, the polypropylene is chemically modified by at least one of hydrophilization, corona discharge, or plasma treatment.

In at least one embodiment, the device also includes a sensor gauge configured to monitor a height of the alkaline capture solution in the solution platform and a pump communicatively coupled to the sensor gauge, the pump being configured to provide additional alkaline capture solution to the platform upon receiving a signal from the sensor gauge that the height of the alkaline capture solution is below a threshold height.

### BRIEF DESCRIPTION OF THE DRAWINGS

For a better understanding of the described examples and to show more clearly how they may be carried into effect, reference will now be made, by way of example, to the accompanying drawings in which:

FIG. 1A shows a conventional DAC method employing two chemical loops; one for air capture with a liquid sorbent and the other for sorbent regeneration and CO₂ separation with a solid compound. The coupled, simultaneous operation of the two chemical loops is important to maintaining a high [sorbent]/[sorbent-CO₂] ratio. The carbonate crystallizer enables a single chemical loop and decoupled DAC process by self-sustaining its capture rate through carbonate precipitation.

FIG. 1B is a line graph that shows that operating a sorbent chemical loop alone leads to a declining capture rate over time due to a decrease in the [sorbent]/[sorbent-CO₂] ratio.

FIG. 1C shows a carbonate crystallizer that harnesses ambient wind and capillarity for DAC according to at least one embodiment described herein. The top color gradient illustrates the KOH concentration profile from the center of the crystallizer to the surface of the precipitate layer, reaching its theoretical solubility limit (22 M). The corresponding decrease in the solubility limit of K₂CO₃ occurs due to the common ion (K⁺) effect (grey color gradient).

FIG. 2A shows a schematic diagram of a conventional DAC method employing two chemical loops: a liquid K loop and a solid Ca loop. The coupled, simultaneous operation of the two chemical loops is vital to maintaining a high [sorbent]/[sorbent-CO₂] ratio. This method also relies on multiple active components, including fans and pumps, contributing to high capital costs.

FIG. 2B shows is a schematic diagram that shows that the carbonate crystallizers described herein enable a single-chemical-loop, streamlined DAC process through evaporation and carbonate precipitation. This process operates passively, requiring minimal energy for pumps, with electrical energy used for KOH regeneration. Additionally, it eliminates the need for solid handling, including collection and transport, a major engineering challenge at scale.

FIG. 3A is a photograph of a crystallizer unit according to at least one embodiment described herein, the unit comprising a solution platform that supplies 4 M KOH to an array of 100 3T crystallizer cords, a floating gauge sensor that monitors solution levels, and a pump for automated replenishment.

FIG. 3B shows a cross-sectional view of the platform showing the accommodation of 3T crystallizer cords.

FIG. 3C shows a cross-sectional view of the platform showing, during the capture stage, the floating gauge locates at an intermediate height to control capillary-driven KOH flow through the crystallizers below.

FIG. 3D shows a cross-sectional view of the platform showing, during the precipitate collection stage, the KOH solution is replaced with water, and the floating gauge is raised to its maximum height to flood the platform, allowing water to rapidly flow through the crystallizers and dissolve the precipitates.

FIG. 3E is schematic showing a capture-precipitate collection cycle. The collected K₂CO₃ solution is sent to an electrochemical cell, where high-purity CO₂ is released and KOH is regenerated.

FIG. 3F is a graph showing volumetric CO₂ capture rates of the crystallizer unit measured over a 25-day period, with relative humidity (RH) shown on the right axis. The capture rates were calculated based on the crystallizers' footprint volume (12×24×46 cm³). Numbers in the graph indicate the concentration of the collected K₂CO₃ solution, with purity given in parentheses. A 2.0 m/s wind-representing the global average of approximately 3.0 m/s—was produced using a fan, and its direction was changed by 90° periodically to simulate varying wind conditions.

FIG. 4A is a schematic that shows that shows measured capture rates of KOH (squares) and NaOH (triangles) solutions at various concentrations compared with theoretical capture rates (“Conventional”). Theoretical curves were calculated based on the conventional capture mechanism involving CO₂ dissolution and diffusion of CO₂ through the capture solution (“Dissol. & Diff.”). At 9 M KOH, the capture rate begins to deviate from theory as the capture mechanism shifts to surface capture of CO₂, followed by diffusion of the resulting CO₃²⁻ ions (“Surf. & Diff.”).

FIG. 4B shows that water evaporation can increase the rate of surface capture by concentrating KOH solutions, and also induce supersaturation of the formed K₂CO₃, facilitating direct CO₂-to-solid conversion.

FIGS. 5A-F each show a side-view and cross-sectional image of (a): 1T, (b): 2T, (c): 3T, (d): 4T, (e): 5T, and (f): 6T PP lines.

FIG. 5G is an image of a capture experiments conducted using the 1T to 9T PP lines and 1.0 M (nominal) KOH solutions. Inset: experimental conditions, including CO₂ concentration and relative humidity (RH).

FIG. 5H is a visualization of the pH gradient along the 3T crystallizer using a pH indicating solution. D_{cord} represents the diameter of the crystallizer, while H_{capill}. stands for the height that the KOH solution attains through capillary rise.

FIG. 5I is an X-ray diffraction (XRD) pattern of the precipitates formed on the PP crystallizers alongside the reference XRD pattern of K₂CO₃·1.5H₂O.

FIG. 5J is a graph showing capture rate of the different PP crystallizers normalized by their cross-sectional area, with values representing means and error bars indicating standard deviation (n=3). Detailed explanations on fitting the capture rates using different models are provided below.

FIG. 5K is a graph showing long-term performance of the 1T crystallizer strands and 3T crystallizer cords with squares and triangles representing their capture rates, respectively. Nine cycles of carbonate precipitation and harvesting were conducted over 22 days. The grey curve illustrates RH changes over time.

FIG. 6A is a line graph showing capture rates of a 3T crystallizer cord and those of a conventional system measured continuously during capture reaction. Initial capture rates are indicated on the left axis with a triangle. Experimental details on the continuous measurement of the capture rates are described below. The abrupt drop in the capture rate of the crystallizer at 1.0 M KOH solution after 40 h (asterisk) is attributed to the formation of a dense, smooth precipitate layer that eventually blocked the capillary pathway.

FIG. 6B is a line graph showing a comparison between the area-normalized capture rates of the carbonate crystallizer (calculated using the initial capture rates in (a)), conventional air contactors^{4,16,31-33} using NaOH or KOH solutions, and theoretically predicted capture rates.

FIG. 6C is a line graph showing area-normalized capture rates of a 3T crystallizer cord at different bulk KOH concentrations, wind speeds, and relative humidities (RHs).

FIGS. 6D and 6E are images of the precipitates formed on the 3T crystallizer cord under <0.3 m/s (FIG. 6D) and 4.0 m/s (FIG. 6E) wind speeds.

FIG. 6F is a line graph showing an amount of evaporated water per a tonne of CO₂ captured with different nominal KOH concentrations, RHs, and air flow rates.

FIG. 7A is an image showing capture using a 3T crystallizer cord with 4.0 M (nominal) KOH solution supplied both from top and bottom.

FIG. 7B is an image of the capture farm featuring arrays of 3T crystallizer cords installed across four layers and five 4.0 M (nominal) KOH solution trays.

FIGS. 7C and 7D are images showing formation and collection of carbonate precipitates on the 3T crystallizer cords after 3.5 days.

FIG. 7E is an image showing, in total, 4.7 kg of carbonate precipitates accumulated over the 25-day period with a water evaporation rate of 12.9 tH₂O/tCO₂.

FIG. 7F is a graph showing the capture rates of the capture farm during 25 days of operation, with the RH provided on the right axis. The CO₂ concentration and temperature during the experiment are given in Figure S40. The distribution of the overall capture rate on Day 3.5 across different floors and rows is provided, where “nF, F/B” indicates the nth floor, front/back row.

FIG. 8A is a scanning electron microscope (SEM) image displaying the cross-section of a PP crystallizer with one strand (1T), revealing narrow capillary gaps between thin PP fibers comprising the crystallizer.

FIG. 8B shows capillary pores within the 1T crystallizer facilitate the transport of KOH solution, while evaporating water at the air/liquid interface.

FIG. 8C is a side-view SEM image of the 1T crystallizer.

FIG. 8D is a schematic illustration demonstrating the crystallization of K₂CO₃ at a specific height of a PP crystallizer where KOH concentration is locally high due to water evaporation along the line.

FIG. 9 is a FT-IR spectrum of the 3T PP cord. The presence of O—H, C═O, and C—O peaks indicate the moderate hydrophilicity of the PP line, which is promotes capillary force.

FIGS. 10A-10F show X-ray photoelectron spectroscopy (XPS) analysis on the 1T PP lines. C 1s XPS spectra of (a) white, (b) brown, and (c) black 1T lines. O 1s XPS spectra of (d) white, (e) brown, and (f) black 1T lines. The peak location of the C—C (284.8 eV in C 1s), C—O (286.2 eV in C 1s; 532.7 eV in O 1s), C═O (288.3 eV in C 1s; 531.2 eV in O 1s), and O—C═O (289.1 eV in C 1s) components matched well with those observed from hydrophilized PP reported in the literature^{S1-S4}.

FIGS. 11A-11I show cross-sectional images of (a) 1T, (b) 2T, (c) 3T, (d) 4T, (e) 5T, (f) 6T, (g) 7T, (h) 8T, and (i) 9T PP lines.

FIGS. 12A-12I show SEM images of the cross-section of (a) 1T, (b) 2T, (c) 3T, (d) 4T, (e) 5T, (f) 6T, (g) 7T, (h) 8T, and (i) 9T PP crystallizers.

FIGS. 13A-13J show photographs of a capillary experiment with 1T, 3T, 6T, and 9T crystallizers, and DI water. 10 mg of Rhodamine B dye was dissolved in 40 ml of DI water to indicate the height of DI water ascended along the crystallizers. The photographs were taken after (a) 1, (b) 2, (c) 5, (d) 10, (e) 20, (f) 40, (g) 60, and (h) 75 minutes, respectively.

FIG. 13I is a graph showing the height of water ascended along the crystallizers with respect to the time.

FIG. 13J is a graph showing the ascending speed of water with respect to the height. The 3T, 6T, and 9T crystallizer cords with inter-strand pores exhibited higher ascending speed than the 1T crystallizer without inter-strand pores.

FIG. 14A shows a graph of water evaporate rate of the 1T, 3T, 6T, and 9T crystallizers, with the relative humidity during the experiment indicated on the right axis.

FIG. 14B shows the evaporation-active surface area of the crystallizers was determined by their diameter and the height of water ascended.

FIGS. 14C and 14D show a graph of an average water evaporation rate of the 1T, 3T, 6T, and 9T crystallizers, and bare water surface. The areal normalization was done using, in FIG. 14C, the evaporation-active area or, in FIG. 14D, the cross-sectional area of the crystallizers and bare water surface. The trend of the crystallizers' evaporation rates matches well with their capture rates.

FIG. 15A shows a concentration profile of the KOH solution from the core to the surface of the crystallizer. At the surface, the concentration of KOH was assumed to reach its solubility limit in water (22 M). The maximum concentration, or solubility limit of K₂CO₃, is indicated as a red dashed line. This graph illustrates that the concentration of KOH in the capture solution exceeds that of K₂CO₃ at the crystallizer surface, resulting in its self-sustained high capture rates.

FIG. 15B shows a concentration profile that indicates, in contrast, in a conventional system, as the capture reaction progresses, K₂CO₃ accumulates within the capture solution while consuming KOH. This results in a continuous increase in its concentration along with a decrease in the concentration of KOH, leading to a decline in the capture rate of the solution over time.

FIGS. 16A-16F are images of an experiment demonstrating an advection-induced flow of water through a 3T crystallizer cord. FIG. 16A shows Rhodamine B dye was applied to the middle of the 3T crystallizer cord while DI water was transported from the bottom through capillary action. FIGS. 16B-16F show that, as the water transverses upward through the crystallizer while undergoing evaporation at the surface, it pushes the dye upward to the maximum height that the water climbs. Notably, the dye never diffuses back to lower height. This indicates that the carbonate formed after capture would not diffuse to the bulk capture solution against this advection-induced flow.

FIGS. 17A-17H show images of a capture experiment that was conducted in a controlled gas environment using a box housing a 3T crystallizer cord inside. A 4.0 M (nominal) KOH solution was used as the capture solution. Three holes on the side wall of the box allowed the flow of 500 sccm of (FIGS. 17A-17C) N₂ or (FIGS. 17D-17G) a mixture of air and CO₂. The CO₂ concentration in the gas mixture was 476 ppm. The flow rate of 500 sccm corresponded to 0.26 m/s, calculated based on the size of the inlet holes.

FIG. 17H is an image that shows, after 3 days of flowing the mixture of air and CO₂, a large amount of precipitates formed which corresponded to a capture rate of 14.4 tCO₂/m²/yr (at 0% RH). No precipitate formation was observed with N₂ even after 4 days.

FIG. 17I is a graph showing that the water evaporation rate remained consistent even with the precipitate formation due to the hydrophilic nature of the K₂CO₃ layer and its high porosity, providing additional capillary pathway towards the air interface.

FIG. 18A is a Fourier-transform infrared (FT-IR) spectrum obtained from carbonate precipitates collected from a 3T crystallizer cord.

FIG. 18B is a line graph showing eight changes of the K₂CO₃·1.5H₂O precipitates after annealing overnight at 120° C. The theoretical weight change after water removal from K₂CO₃·1.5H₂O is represented by black line (0.837). Other lines indicate weight changes calculated under the assumption of the presence of KOH residues in the precipitates.

FIGS. 18C and 18D are graphs showing the carbonate precipitates obtained from the 3T crystallizer cord and (C) 1.0 and (D) 4.0 M KOH solutions were air-dried for a couple of days or weeks. Then, the dried K₂CO₃·1.5H₂O precipitates (165 mg) were dissolved in DI water (10 ml) for pH measurement (please refer to the left axis). The pH of the 0.1 M K₂CO₃ (synthetic) solution is indicated by the dashed line at 11.55. The difference between the pH of the precipitate solution and synthetic K₂CO₃ (11.55) was assumed to be due to the presence of KOH residues. The corresponding KOH weight percentage was calculated and plotted as black data points (please refer to the right axis).

FIGS. 19A-19D are images that show a CO₂ capture experiment with 6T crystallizers and 1.0 M (nominal) KOH and NaOH capture solutions. The experimental conditions were 431±11 ppm CO₂, 23.3±0.9° C., and 19.6±3.5% RH, and air flow rate was <0.3 m/s (wind gauge limit). Images of the crystallizers after (a) 0, (b) 1, (c) 2, and (d) 4 days of the experiment.

FIG. 19E is a graph showing the amount of water evaporation from the 1.0 M KOH and NaOH solutions.

FIG. 20 is a graph showing theoretical capture rates of KOH and NaOH solutions, and those of conventional air contactors^{S5-S9} using NaOH or KOH solutions indicated as different shapes.

FIGS. 21A-21G show SEM images and energy dispersive spectroscopy (EDS) mappings of the crystallizer surface after the capture experiment (Figure S10). The surface of the 6T crystallizer that hosted (A)-(C) 1.0 M NaOH and (D)-(G) 1.0 M KOH solutions.

FIG. 21H is a SEM image of a K₂CO₃ crystal scraped off from the crystallizer.

FIG. 22A-22C are images showing Nylon lines were initially used as a carbonate crystallizer with a 1.0 M KOH capture solution, given nylon's moderate stability in alkaline conditions. FIG. 22C shows, however, during operation, the surface of the nylon lines became highly alkaline after undergoing water evaporation beyond the stability limit of nylon. The nylon lines were torn apart at the location where carbonate precipitates formed (where it was locally highly alkaline) during precipitate collection.

FIG. 23 is a graph showing the amount of carbonate precipitates collected from the 1T to 9T crystallizers. The values represent means and error bars indicate standard deviation (n=3).

FIG. 24 is a graph showing the amount of precipitates collected from the 1T to 9T crystallizers with respect to the amount of water evaporated. 1.0 M KOH solutions were used for the capture solution. Experimental conditions are indicated in the bottom-right corner.

FIGS. 25A-251 show schematic cross-sections of the 1T to 9T crystallizers, respectively.

FIGS. 25J-25R depict the air/liquid interfaces where evaporation primarily occurred as determined by Model 1. The grey-colored region was assumed to be inactive for water evaporation based on findings from the 1T and 2T crystallizers.

FIGS. 25S-25AA show black dashed curves illustrating the air/liquid interfaces where evaporation predominantly occurred as determined by Model 2. Purple boxes indicate the fully wetted region of the crystallizers due to efficient supply of KOH solution through the inter-strand pores.

FIG. 26 is a graph showing different evaporation models explaining the capture rates of the 1T to 9T crystallizers.

FIG. 27 is an image of a long-term performance test performed using the 1T crystallizer strand and 3T crystallizer cords. 500 ml of 1.0 M (nominal) KOH solution was used as the capture solution. The experimental conditions were 440±23 ppm CO₂, 23±1° C., and 19.8±5.8% RH, and wind speed was <0.3 m/s (wind gauge limit).

FIGS. 28A-28C are images of the 1T crystallizer after carbonate precipitation. The growth of the precipitates during CO₂ capture widened the gaps between the PP fibers and destroyed the structure of the crystallizer.

FIGS. 28D-28F are images of the 3T crystallizer cord after carbonate precipitation. The inter-strand pore in the 3T crystallizer cord facilitated carbonate precipitation at the crystallizer surface, thereby preserving the structure of the crystallizer.

FIGS. 29A-29F are SEM images and EDS mapping of the cross-section of the (a,b) 1T, (c,d) 3T, and (e,f) 6T crystallizers after carbonate precipitation. The EDS mapping of the 1T crystallizer (b) clearly indicates that the formation of carbonate precipitates destroyed the structure of the 1T crystallizer.

FIG. 30 is a sequence of images showing a long-term performance test performed using the 6T crystallizer. 500 ml of 1.0 M (nominal) KOH solution was used as the capture solution. The experimental conditions were 429±16 ppm CO₂, 231° C., and 22.5±6.1% RH, and wind speed was <0.3 m/s (wind gauge limit).

FIG. 31 is a graph showing the capture rate of the 6T crystallizer used in the above long-term performance test (FIG. 30) with the relative humidity (RH) during the experiment indicated on the right axis.

FIGS. 32A-32E are images of the carbonate precipitates formed using (a) 1.0, (b) 3.0, (c) 4.0, (d) 6.0, and (e) 8.0 M KOH solutions during continuous measurement of crystallizer capture rate at 403 ppm CO₂, 2% RH, and 24.5° C.

FIG. 33A is a graph showing a concentration of KOH capture solutions before and after a capture experiment using a 3T crystallizer cord.

FIG. 33B is a graph showing mass of precipitates collected after the capture experiment (green) and their expected value (orange) calculated using pre-determined ratios between the amounts of evaporated water and captured CO₂ (tH₂O/tCO₂) at different KOH concentrations. The chemical formula of K₂CO₃·1.5H₂O was used for the chemical composition of the precipitates.

FIGS. 33C-33F are graphs showing expected mass change calculated using the mass of evaporated water determined from the volume change of the capture solution and the expected amount of captured CO₂ (using the tH₂O/tCO₂ ratio), closely matched the actual mass change measured by the balance for KOH concentrations of (c) 3.0 M, (d) 4.0 M, (e) 6.0 M, and (f) 8.0 M.

FIG. 33G is a graph showing mass of CO₂ captured by the crystallizer over time.

FIGS. 34A-34D are images showing a capillary experiment with DI water, 0.7, 1.0, and 2.0 M (nominal) KOH solutions. 10 mg of Rhodamine B was dissolved in each solution (40 ml). The photographs were taken after (a) 0, (b) 20, (c) 40, and (d) 50 min (when all solutions reached their maximum height).

FIG. 34E is a graph showing the height that DI water climbed was the highest, followed by 0.7 M, 1.0 M, and 2.0 M KOH solutions. The heights of the KOH solutions were similar to those of the carbonate precipitates formed with those KOH solutions.

FIG. 34F shows a line graph where the height ratio of the different concentrations of KOH solutions to DI water predicted by the Washburn equation. The dashed line indicates the height ratio of the 2.0 M KOH solution calculated from the experiment in FIG. 34D

FIG. 34G is a graph showing the height of water and KOH solutions ascended along the crystallizers with respect to time.

FIG. 34H is a graph showing the ascending speed of water and KOH solutions with respect to height.

FIG. 35 is a graph showing the lengths of carbonate precipitates formed under various experimental conditions.

FIG. 36A is a photograph of a setup used to investigate the effects of wind on the capture rate of the 3T crystallizer cord. 1.0, 2.0, 3.0, and 4.0 M (nominal) KOH solutions were used as the capture solution, with a wind speed of 2.5 m/s measured by a wind gauge.

FIGS. 36B-36F are photographs of the 3T crystallizer cords after (b) 0, (c) 1, (d) 2, and (e,f) 3 days of experiment.

FIG. 37A is a photograph of an experimental setup used to investigate the effects of wind on the capture rate of the 3T crystallizer. 1.0, 2.0, 3.0, and 4.0 M (nominal) KOH solutions were used as the capture solution, with a wind speed of 4.0 m/s measured by a wind gauge.

FIGS. 37B-37F are photographs of the 3T crystallizer cords after (b) 0, (c) 1, (d) 2, and (e,f) 3 days of experiment.

FIGS. 38A-38C are line graphs of: (a) CO₂ concentration, (b) relative humidity (RH), and (c) temperature during the experiments to investigate the effects of wind speed on the capture rate (FIGS. 35 and 36). When the wind speed was 4.0 m/s (black curves), the average CO₂ concentration, RH, and temperature were 435±23 ppm, 22.3±3.1%, and 23.1±1° C., respectively. At a wind speed of 2.5 m/s (red curves), the average CO₂ concentration, RH, and temperature were 433±22 ppm, 21.6±2.8%, and 23.41 1° C., respectively.

FIG. 39 shows the effect of bulk KOH concentration (pH) and wind on the capture rate of the carbonate crystallizer. High-pH solutions and wind increase the surface area of the crystallizer active to CO₂ capture due to the locally elevated pH levels. This results in the formation of longer precipitates.

FIG. 40 shows transfer of K⁺ from the KOH solution to K₂CO₃ precipitates. The mole of K⁺ in the evaporated KOH solution is calculated based on bulk concentrations of KOH; 1.0, 2.0, 3.0, and 4.0 M (nominal). The actual KOH concentrations were 0.9, 1.8, 2.7, and 3.6 M, excluding 10 wt % of water in the KOH flakes. Red data points represent the mole of K⁺ in the collected K₂CO₃ precipitates. The resulting fitted curve exhibited a slope of 1.033±0.01, indicating a K⁺ deficit of 3%. When accounting for the precipitates left inside the crystallizer, the K⁺ transfer percentage approached almost 100%. The 3% deficit arises due to the physical limitation of collecting 100% of the precipitates from the crystallizer and does not imply a loss of K⁺.

FIGS. 41A-41U show images of a long-term performance test performed using the 3T crystallizer cord while introducing 4.0 M KOH solution from top and bottom. The wind speed was <0.3 m/s (wind gauge limit).

FIG. 42A is a graph showing the resulting capture rate of the 3T crystallizer cord used in the above long-term performance test (Figure S34) with the RH (average of 19.3±6.3%) during the experiment indicated on the right axis.

FIGS. 42b and 42C are graphs showing the (b) CO₂ concentration (average of 427±24 ppm) and (c) temperature (average of 24±1° C.) during the experiment.

FIG. 42D is a graph showing polynomial functions were employed to fit the capture rates (red) and relative humidities (black) during the experiment. The comparison between these two polynomial fitting curves reveals the inverse relationship between the capture rate and relative humidity.

FIGS. 43A-43C are images of a capture farm after (a) 0, (b) 2, and (c) 3.5 days of experiment.

FIGS. 43D-43K are images of each floor of the capture farm after (d-g) 2 and (h-k) 3 days of experiment.

FIGS. 43L-430 are images of precipitate collection after 3.5 days of experiment.

FIGS. 44A-44E are images of a capture farm after (a) 0, (b) 1, (c) 2, (d) 3, and (e) 3.5 days of experiment.

FIG. 45 shows arrays of 3T crystallizer cords used in the capture farm had a 2 cm gap between neighboring crystallizers and occupied an installation area of 27×2 cm². This area was used for calculating the capture rate of the capture farm.

FIGS. 46A-6G are images of the capture farm during the 7 cycles of operation for 25 days.

FIGS. 47A and 47B show: (a) CO₂ concentration and (b) temperature were monitored during the capture farm experiment. A wind speed of ˜0.6 m/s was generated randomly for 3-6 hours per day using large fans to simulate the intermittency of ambient wind.

FIG. 48A is a graph showing capture rates of major biomass crops, assuming a harvesting cycle of once a year as commonly practiced for corn and sugar cane.

FIG. 48B is a graph showing a comparison of the areal rate of carbon capture between the biomass crops and capture farm.

FIG. 49A is a schematic showing integration of an electrocatalysis cell with a carbonate crystallizer. The electrocatalysis cell comprises mainly three compartments: the H₂-evolution reaction (HER, left), acidification (middle), and H₂-oxidation reaction (HOR, right) chambers. KOH regeneration occurs in the HER chamber while CO₂ is released from the acidification chamber.

FIG. 49B is a graph showing the full-cell voltage of the electrocatalysis cell during the three cycles of operation. The arrows indicate an increase in cell voltage after the complete consumption of carbonate/bicarbonate and the onset of proton crossover.

FIG. 49C is a graph showing the pH changes (black curve, left axis) of the capture solution and current efficiency (purple curve, right axis) of the cell.

FIG. 49D is a graph showing the CO₂ release from the acidification chamber during the three cycles. The amount of CO₂ released during these experiments was 39.4±1.1 mmol, which closely corresponded to the molar amount of the K₂CO₃·1.5H₂O (40 mmol) employed in the acidification chamber.

FIG. 49E is a graph showing the capture rate and tH₂O/tCO₂ of a 3T carbonate crystallizer cord using the three batches of the electrochemically generated KOH solution from the electrochemical cell. The dashed lines indicate the average capture rate and tH₂O/tCO₂ of 3T crystallizer cords achieved with synthetic 3.6 M (actual) KOH solutions.

FIG. 50 shows three standard curves obtained across different pH ranges (specifically, KOH concentrations) were used to measure the concentration of the capture solution generated from an electrochemical cell. The actual pHs of such concentrated KOH solutions are hard to measure^{S10} in situ, and hence, the measured pHs were used to measure the KOH concentration. The denoted KOH concentrations (104 to 4.0 M) represent actual values, not nominal.

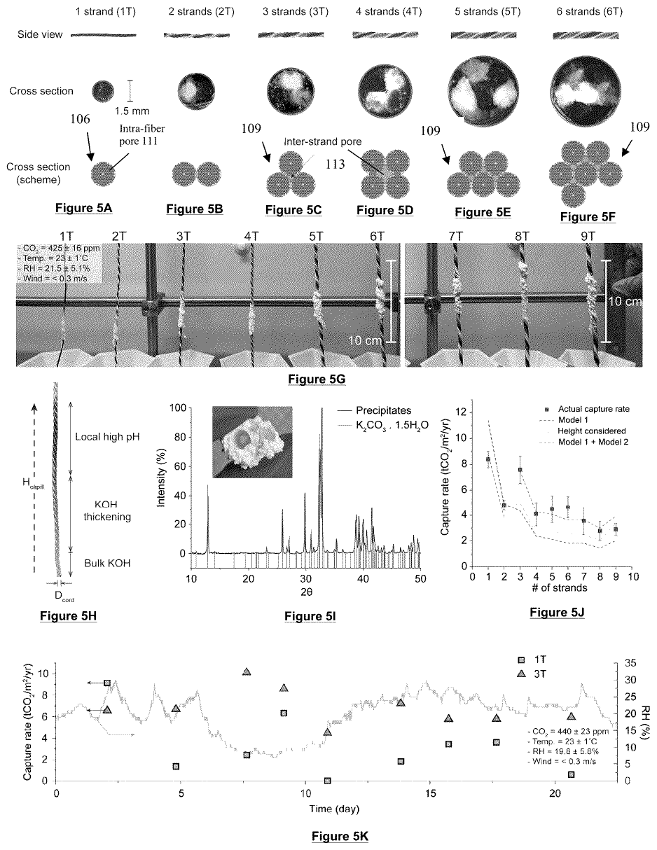

FIG. 5I is a graph showing pH changes in the acidification chamber of the electrocatalysis cell. In the first half of the operation (0 to ˜12.5 h), carbonate reacts with protons, converting to bicarbonate, without any gaseous CO₂ being released from the acidification compartment. During the second half of the operation (12.5 to 26 h), bicarbonate continuously reacts with protons, resulting in the release of gaseous CO₂. The pH rapidly drops after 26 hours, indicating a complete conversion of the bicarbonate to gaseous CO₂.

FIG. 52 is a photograph of the gaseous CO₂ released from the electrocatalysis cell. The red circles indicate gas bubbles formed by the CO₂ released from the cell.

FIG. 53 is a graph showing full-cell voltage of the electrocatalysis cell at various middle chamber thicknesses across different current densities ranging from −10 to −300 mA/cm². A solution of 1 M KCl+2 M K₂CO₃ was used as the solution in the middle chamber.

FIG. 54 is a graph showing a standard curve used to quantify the CO₂ release amount was obtained by varying the flow rate of CO₂ while maintaining a fixed flow of N₂ (15 sccm). The flow rates were measured using a flow meter and the x-axis values indicate the flow rate reading after subtracting the N₂ baseline flow rate. The actual flow rate of the gas streams was measured three times using a bubble flow meter and the average value was plotted as the y-axis value of the data points.

FIG. 55A is a schematic workflow of the capture farm in conjunction with electrochemical direct air capture (eDAC) plant. Inset (‘Carbonate crystallizer’): carbonate crystallizers capture CO₂ from the atmosphere while evaporating water, leading to the formation of K₂CO₃ precipitates. Powered by renewable energy sources from solar and wind farms, the eDAC plant releases a pure CO₂ stream through the acidification of the K₂CO₃ collected from the capture farm (“K₂CO₃ harvesting”), simultaneously regenerating a KOH solution. The resulting CO₂ stream is sequestered underground, while the regenerated KOH solution is transported back to the capture farm (“KOH supply”).

FIG. 55B shows annual production rate (gigatonnes per year) of major crops including cereals, sugar crops, and vegetabless¹¹ in comparison with the 2050 target CO₂ removal rate (“DAC target”). Dashed lines denote the elemental carbon content in the crops or captured CO₂.

FIG. 55C shows a comparison between the capital costs of the conventional air contactor^{S5} and those of the capture farm. The capital costs of reference cases, a corn farm and Li evaporation pond (dashed lines), were calculated based on the same size as our capture farm, which is required to capture 1 MtCO₂/yr.

### DETAILED DESCRIPTION OF VARIOUS EXAMPLES

Various devices, systems, or processes will be described below to provide an example of each claimed invention. No example described below limits any claimed invention and any claimed invention may cover processes, systems, or devices that differ from those described below. The claimed inventions are not limited to devices, systems, or processes having all of the features of any one devices, system, or process described below or to features common to multiple or all of the devices, systems, or processes described below. It is possible that a device, system, or process described below is not an example of any claimed invention. Any invention disclosed in a device, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

Direct air capture (DAC) of CO₂ is needed to mitigate past emissions and those of persistent and difficult-to-abate sources. Current DAC sorbents slow in capture rate as the reaction progresses—a consequence of Le Chatelier's principle—and thus require cyclic regeneration to maintain capture rate over time. This requirement escalates the complexity and cost, the main barriers to scaling DAC.

According to aspects of the present teachings, local evaporation of capture fluid and carbonate crystallization can be combined to enable relatively high-rate CO₂ capture that can be self-sustaining. In some examples, a wicking substrate can concentrate alkaline capture solution at the air interface and capture CO₂ in the form of carbonate salt. The porous nature of the formed salt can provide continuous air contact with the concentrated capture solution and enable continuous growth of crystal aggregates (e.g. on a scale of tens of centimeters). With this approach, in some examples, vertically stacked arrays of carbonate crystallizers may achieve an areal capture rate of 1.7 MtCO₂/km²/yr (1000-fold that of biomass) and may help reduce the capital requirements by an order of magnitude compared to some industrial air contactors.

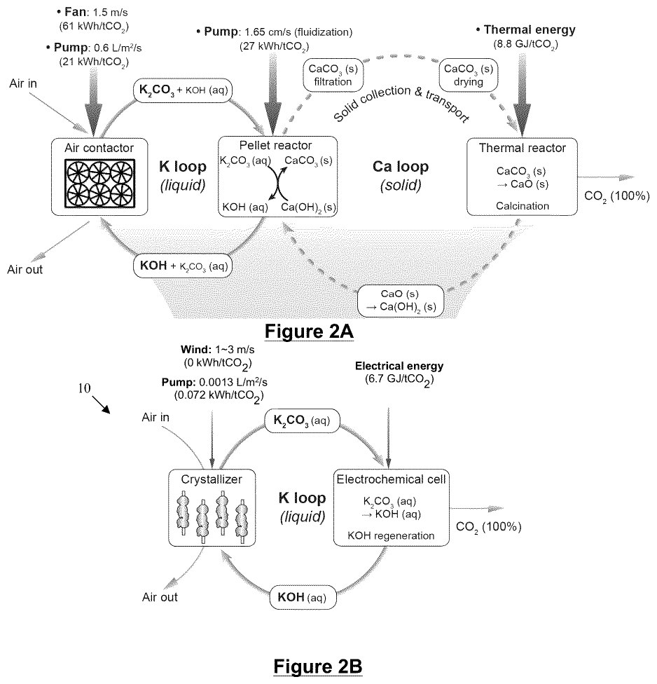

Turning now to FIG. 2A, shown therein is a conventional DAC method employing two chemical loops: a liquid K loop and a solid Ca loop. The coupled, simultaneous operation of the two chemical loops is vital to maintaining a high [sorbent]/[sorbent-CO₂] ratio. This method also relies on multiple active components, including fans and pumps, contributing to high capital costs.

FIG. 2B shows a carbonate crystallizer process 10 according to at least one embodiment described herein. The process enables a single-chemical-loop, streamlined DAC process through evaporation and carbonate precipitation. Process 10 operates passively, requiring minimal energy for pumps, with electrical energy used for KOH regeneration. Additionally, it eliminates the need for solid handling, including collection and transport, a major engineering challenge at scale.

Turning to FIG. 3A, shown therein is a crystallizer device 100 according to at least one embodiment described herein. The crystallizer device 100 offers many advantages over present devices, including but not limited to being automated and a modular unit for scalable passive DAC.

Crystallizer device 100 includes a solution platform 102 that supplies an alkaline capture solution (e.g., 4M KOH) to an array 104 of one or more crystallizer strands 106. In the embodiment shown in FIG. 3A, the array 104 includes 100 crystallizer cords 109, but it should be understood that other arrangements are within the scope of the embodiment.

Turning now to FIGS. 5A-5F, each of the strands 106 is shaped to capture alkaline capture solution from the solution platform 102 by capillary force. In at least one embodiment, each strand includes is a one or more fibres 107 therein. For example, in at least one embodiment, each strand 106 includes a plurality of about 70 μm-thick fibers 107, which together are woven into a strand 106. Fibres 107 are in contact with one another to minimize any space or cavities therebetween.

One or more strands 106 may be twisted together to form a cord 109. Herein, the format “nT” is used to indicate how many strands 106 form a cord 109, where n represents the number of strands. For example, a “3T” cord 109 is made by twisting, or weaving, three strands 106 together.

In at least one embodiment, capillarity (i.e. capillary force that produces motion of the solution along the cord 109) is induced by the thin pores or channels 111 (i.e., intra-fiber pores 111) between individual fibers 107 as well as wider pores or channels 113 between individual strands 106 (i.e., intra-strand pores 113).

It should be understood herein that the term “fibre” or “fiber” is used to describe a polymeric filament having a diameter in a range of about 50 microns to about 100 microns, or in a range of about 50 microns to about 200 microns, or of about 100 microns to about 200 microns, or of about 50 microns, 70 microns, 100 microns, 150 microns or 200 microns.

It should be understood herein that the term “strand” is used to describe a polymeric filament comprising a plurality of fibers, the strand having a diameter in a range of about 1 mm to about 5 mm, or in a range of about 0.5 mm to about 5 mm, or in a range of about 1 mm to about 3 mm, or in a range of about 1 mm to about 2 mm, or of about 0.5 mm, 1 mm, 1.5 mm, 2 mm, 2.5 mm, 3 mm, 3.5 mm, 4 mm, 4.5 mm or 5 mm.

It should be understood herein that the term “cord” is used to describe a polymeric filament comprising a plurality of strands, for example 2 strands, 3 strands, 4 strands, 5 strands, 6 strands, 7 strands, 8 strands, 9 strands or more than 9 strands. The strands may be twisted together, woven together, or parallel with each other.

When a cord 107 is introduced into the alkaline capture solution, the alkaline capture solution (e.g. KOH solution) wets the entire cord 109 as far as the capillary force allows, and CO₂ capture and crystallization occurs on a surface 113 of the cord 109 where surface 113 is exposed to ambient air.

Alkaline capture solution is drawn through cord 109 upwardly from a first end 115 of the cord 109 immersed in the alkaline capture solution and along an ascending portion 117 of the cord 109. As the alkaline capture solution reaches a bend in the cord 109, gravity pulls the alkaline capture solution downwardly towards a second end 119 of the cord 109.

In the embodiment shown in FIG. 3A, a floating gauge sensor 108 is provided that monitors a level of the alkaline capture solution within the solution platform 102, and a pump 110 for automated replenishment of the alkaline capture solution in the solution platform 102.

During the capture stage, the floating gauge locates at an intermediate height to control capillary-driven alkaline capture solution flow through the crystallizer strands. As alkaline capture solution travels downwardly through the strands 106, water evaporates from the alkaline capture solution, thereby increasing the concentration of the alkaline capture solution. As the concentration increases, the alkaline capture solution moves outwardly within the strands 106 to an outer surface where it reacts with CO₂ in the ambient air.

The reaction of the high concentration alkaline capture solution with the CO₂ causes the formation of a precipitate on the outer surface, or crystallization surface, of each strand 106.

In FIG. 3D, during the precipitate collection stage, the alkaline capture solution is replaced with water and the floating gauge is raised to its maximum height to flood the platform, allowing water to rapidly flow through the crystallizer strands and dissolve the precipitates. The precipitates fall to a tray below the strands 106 where they can be collected.

In FIG. 3E, a schematic of the crystallizer unit's capture-precipitate collection cycle is shown. The collected precipitate (e.g., K₂CO₃ solution) is sent to an electrochemical cell, where high-purity CO₂ is released and KOH is regenerated.

As shown in FIG. 3F, volumetric CO₂ capture rates of the crystallizer unit measured over a 25-day period are provided, with relative humidity (RH) shown on the right axis. The capture rates were calculated based on the crystallizers' footprint volume (12×24×46 cm³). Numbers in the graph indicate the concentration of the collected K₂CO₃ solution, with purity given in parentheses. A 2.0 m/s wind-representing the global average of approximately 3.0 m/s—was produced using a fan, and its direction was changed by 90° periodically to simulate varying wind conditions.

This vertical configuration shown in the Figures is amenable to scaling. This automated, modular crystallizer unit in which a solution platform supplies KOH solution to dense arrays of 100 3T crystallizer cords.

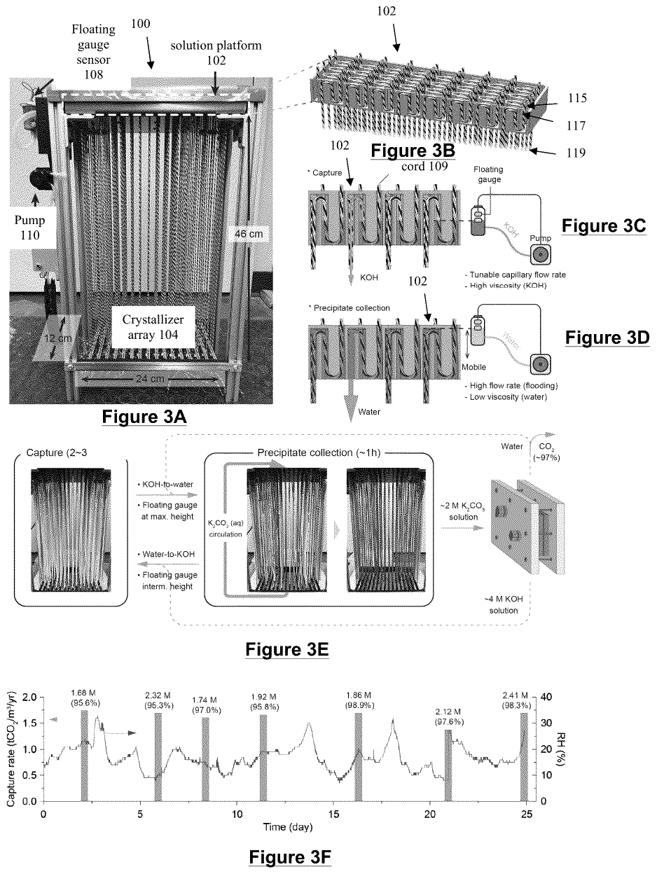

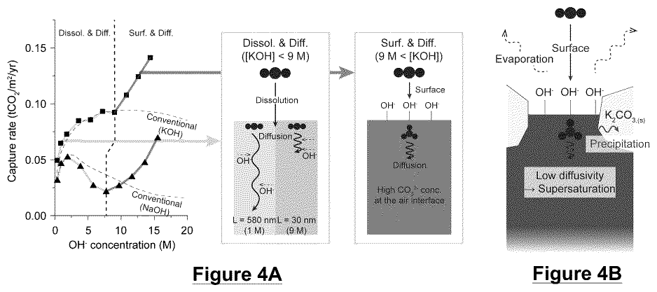

FIG. 4A-4F shows cross-sections of individual strands 106 in various arrangements.

As noted above, floating gauge sensor 108 beside the platform 102 controls the capillary flow rate in the crystallizer strands 106 through its vertical position and intermittently activates a pump to replenish KOH solution when the solution level drops (FIG. 3C). This design maximizes areal efficiency while minimizing active components.

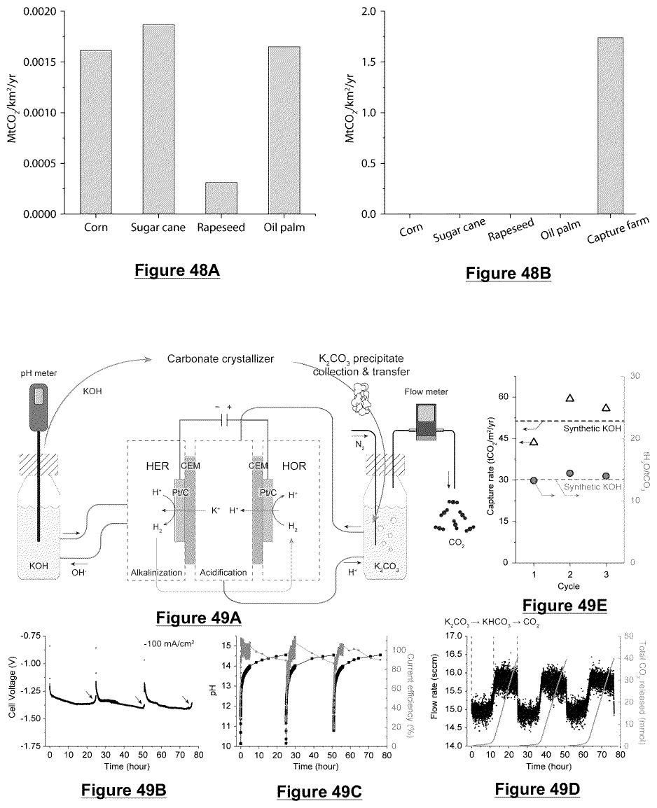

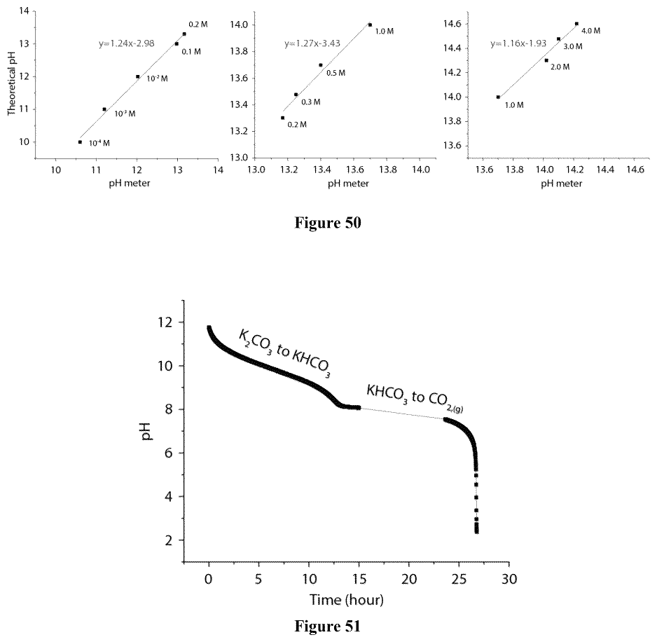

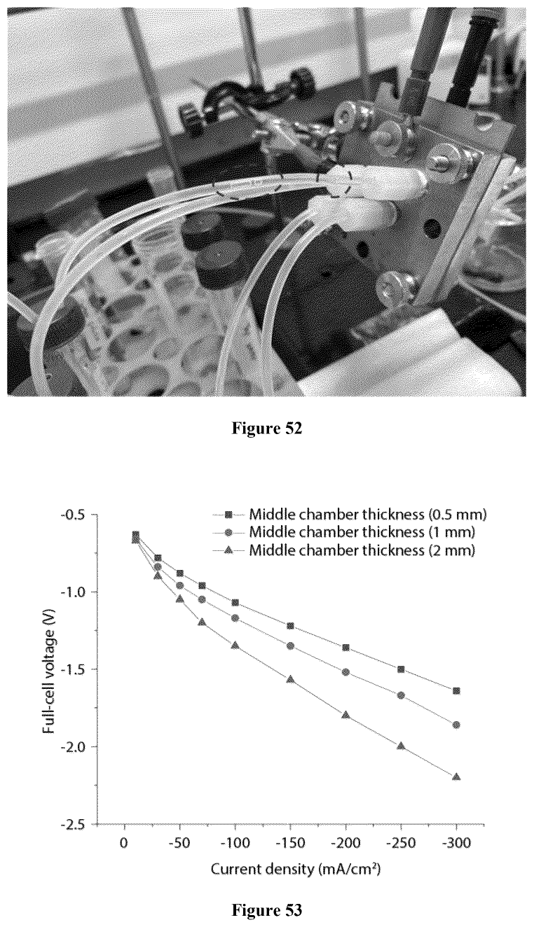

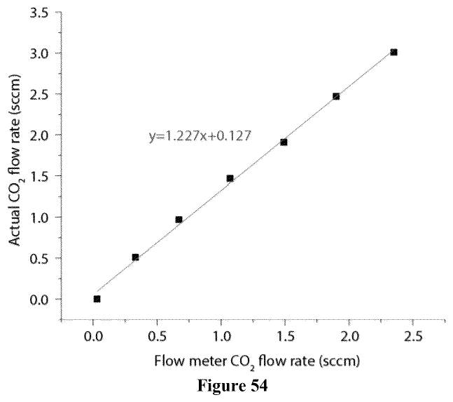

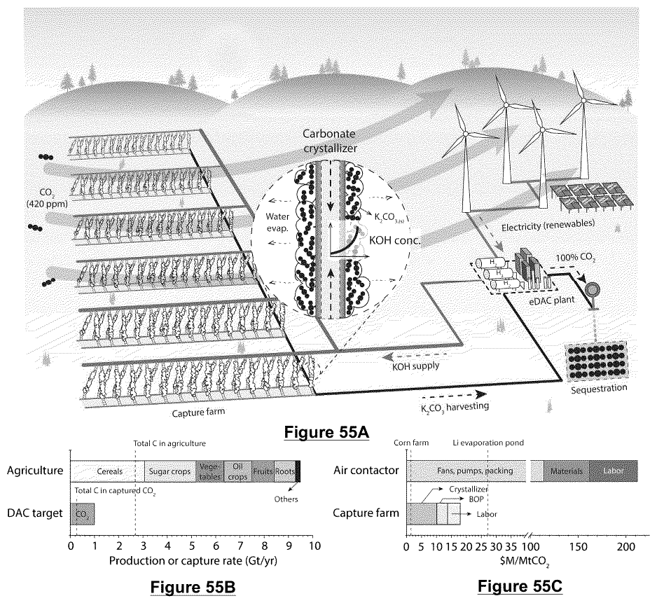

After a period of time, for example 2-3 days, of capture on the crystallizer surface, carbonate precipitates can be collected by replacing the KOH solution in the platform 102 with water, which floods the platform 102 and flows through the crystallizer strands 106 to dissolve the precipitates (FIGS. 3D and 3E). The resulting K₂CO₃ solution circulates back to the platform 102 and is concentrated over time. In one example, the precipitate collection occurs within one hour, although higher flow rates may reduce that time to a few minutes (see, for example, FIGS. 49 and 50).

In one example that occurred over 25 days and 7 capture-collection cycles under moderate (2.0 m/s) wind speed, the device 100 maintained an average volumetric capture rate of 1.66 tCO₂/m³/yr while producing 2.01 M K₂CO₃ solutions with an average purity of 96.9% (the remainder being KOH; see FIG. 3F and FIG. 5I). This rate, enabled by rapid CO₂-to-carbonate crystallization, approaches that of conventional fan-assisted, packing-based contactors (3.1 tCO₂/m³/yr)⁴, despite operating with 83% lower specific surface area for capture (35<<220 m²/m³)⁴. Normalized by air-exposed surface area, the crystallizers achieve an areal capture rate 3.2 times that of conventional contactors.

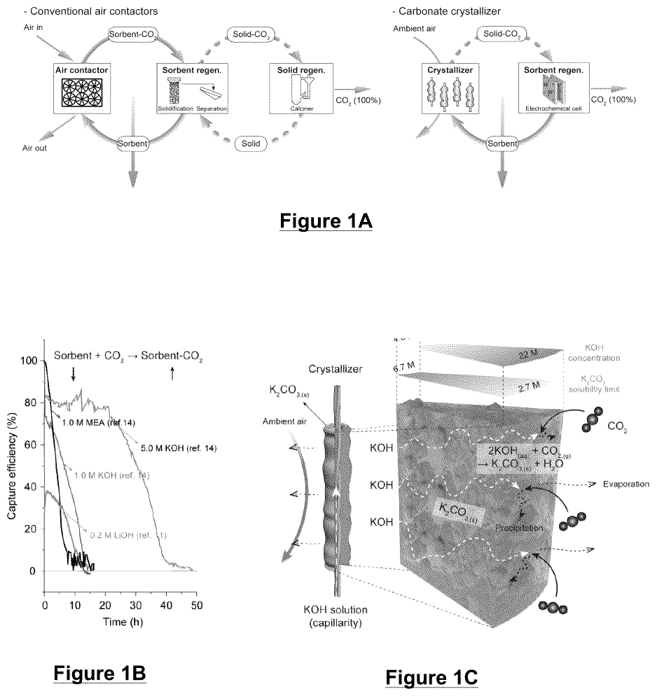

In at least one embodiment, the crystallizer 100 can operate passively under ambient wind conditions owing to its low aerosol formation tendency and porous structure, which facilitates air interaction from any direction. Made from inexpensive polypropylene (PP), the crystallizer may, in some embodiments, enable passive and scalable DAC without requiring fans, pumps, or a separate chemical loop for carbonate solidification (FIG. 1 and FIG. 52)—components that account for over 60% of the cost in liquid sorbent-based DAC^{4,7}.

### EXAMPLES

### Electrochemical Processing of Precipitates

To process the K₂CO₃ solution from the crystallizer a three-compartment electrochemical cell may be operated to regenerate the KOH and release high-purity CO₂ for sequestration or utilization^{11,39-41}. The electrochemical cell employs H₂-evolution reaction (HER) at the cathode electrode for KOH regeneration, coupled with H₂-oxidation reaction (HOR) occurring at the anode electrode for CO₂ release (see FIG. 52).

The electrocatalysis cell regenerated a KOH solution at a concentration of 3.6 M and with a current efficiency of 88.6±0.021%. The amount of CO₂ released during these experiments closely corresponded to the molar amount of K₂CO₃ employed in the acidification chamber ((see FIG. 52)). This high efficiency may be attributed to the high purity of the K₂CO₃ from the crystallizer device, which is unattainable with conventional air contactors without a significant reduction in capture rate. This electrochemical system represents low energy costs (6.7 GJ/tCO₂) while operating at industrially-relevant current densities (≥100 mA/cm²).

With this regenerated KOH solution, three cycles of the DAC experiment were performed and found that the resulting capture rates and tH₂O/tCO₂ closely matched with those obtained with a synthetic 3.6 M KOH solution (see FIG. 49). These findings confirm the full K loop, including the capture by crystallizers, K₂CO₃ harvesting, CO₂ release, and the regeneration and reuse of KOH as delineated in FIG. 55, and demonstrate the feasibility of a single-chemical-loop DAC operation.

It was first sought to understand the fundamental limitations of capture at a liquid-air interface, limitations that slow the progression of the capture process. It was found that capture rate, under typical conditions, is slowed due to CO₂ dissolution, diffusion and reaction—processes that can be accelerated if the solution is concentrated via evaporation. At very high alkalinities, direct solidification could shift the solution-phase equilibrium to sustain the high capture rate. On this basis a DAC method was designed that achieves high-rate capture via evaporation and sustains that performance through in situ carbonate crystallization. With direct production of solid carbonate, only a single chemical loop is required. This air contact approach is passive, and can help avoid the use of industrial fans and packing materials. The resulting carbonate aggregates, which can form on a scale of tens of centimeters, may be harvested mechanically. Woven commercial polypropylene strands were employed to transport capture solution and ambient wind to transport air. These crystallizers facilitate the transportation of KOH alkaline capture solution via capillary action in their cores, and concentrate the alkaline solution (from 4 M to >12 M) via evaporation at the air interface. This highly alkaline surface rapidly captures CO₂ at the air interface, and the resulting K₂CO₃ precipitates at the interface where the K₂CO₃ is supersaturated beyond the solubility limit—itself a function of local KOH concentration. The resulting porous carbonate precipitate layer then provides additional capillary pathways, enabling continuous capture and precipitation processes. Moreover, this solubility difference between KOH and K₂CO₃ results in a high local concentration of KOH relative to K₂CO₃ (a high [sorbent]/[sorbent-CO₂] ratio), leading to capture that can be both high-rate and sustained.

### Principle of Carbonate Crystallization

The inventors began by analyzing the capture behavior of alkaline solutions in the presence of air. Conventional capture theory^{16,17} predicts a decrease in capture rate beyond a certain concentration due to reduced solubility and diffusivity of CO₂, and experiments here reflected this behavior up to moderate (<9 M OH⁻) alkalinity. This regime is typical of air contactors (1˜3 M OH⁻). However, it was found that—if permitted to concentrate further—the capture rate of KOH and NaOH increases sharply. It was noted that the activity coefficient of both KOH and NaOH increases abruptly¹⁸ with increasing concentrations, as the ratio of water molecules to OH⁻ ions become very low (<3 at 9 M)¹⁹. Additionally, the specific diffusion length of gaseous CO₂ into the capture solution diminishes to approximately 30 nm at 9 M KOH. These factors imply that at high OH⁻ concentrations—beyond that accessible with conventional air contactors^{16,20,21}—the OH⁻ ions are exposed at the solution surface and can directly react with gaseous CO₂ without being limited by the solubility of CO₂. The capture mechanism would then shift to a surface reaction between CO₂ and OH⁻, followed by the diffusion of the resulting CO₃²⁻ into the bulk solution (“Surf. & Diff.” in FIG. 4A).

The inventors then sought ways to lever the high-rate surface capture by concentrated KOH solutions and the low mobility of CO₃²⁻ ions in concentrated alkaline solutions to enable direct CO₂-to-solid conversion. The inventors looked to the crystal growth literature, particularly methods of evaporation-induced salt concentration and precipitation^{22,23}, and the use of capillary networks to direct the precipitation of salt^{24,25}. The inventors then sought a means to evaporatively concentrate KOH and supersaturate the formed CO₃²⁻ ions to achieve precipitation at the air interface (FIG. 4B).

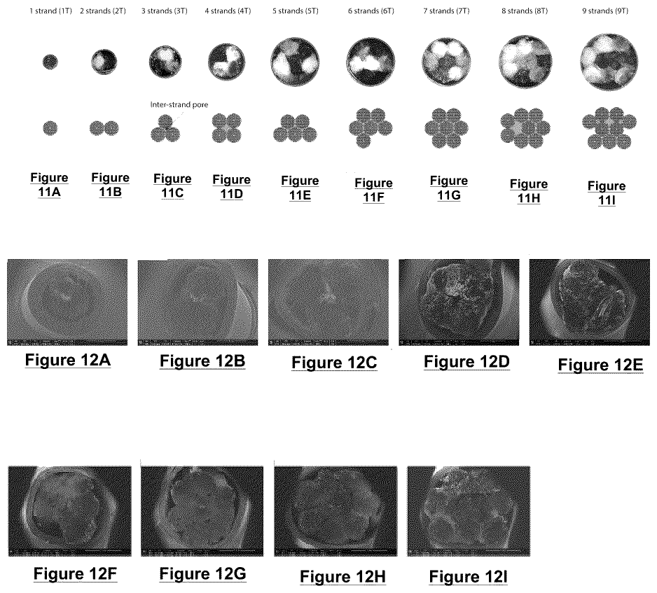

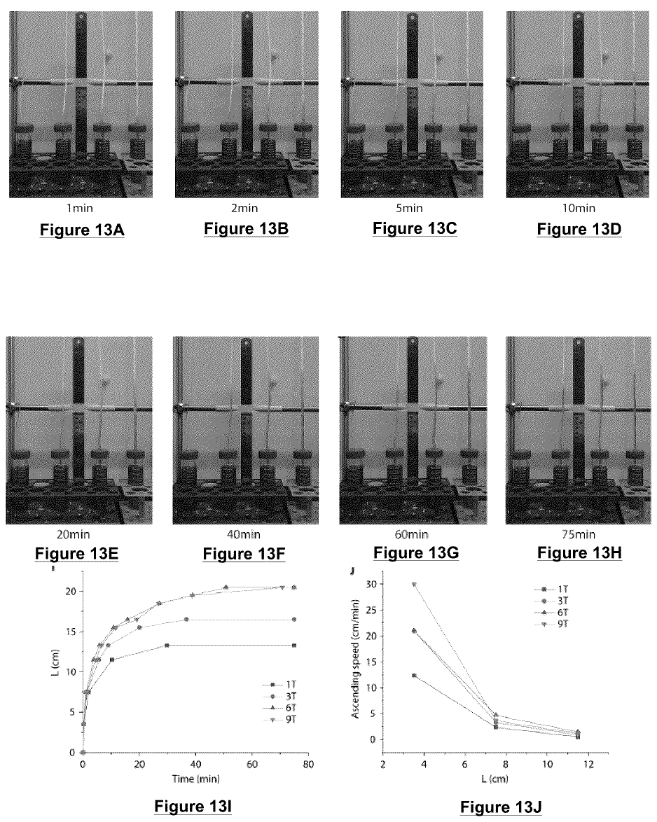

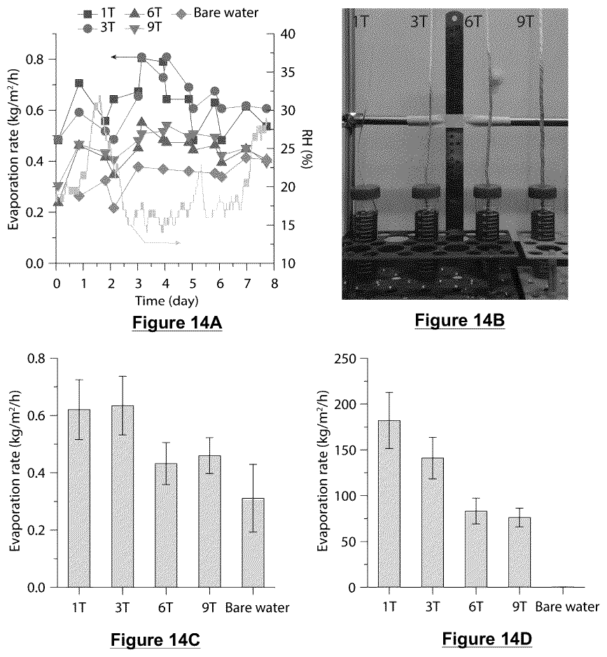

To test this concept, the inventors considered the form of a wicking substrate, herein also referred to as a polymeric strand, with capillary channels that could transport the capture solution (e.g., alkaline) while exposing it to the air, and opted for a line geometry that would provide a high surface-to-volume ratio, a thin boundary layer and exposure independent of wind direction. Polypropylene (PP) was selected as a material due to its exceptional stability in highly alkaline conditions, low cost, and already-scaled production volume²⁶. Native PP is generally hydrophobic, but PP fibers are routinely rendered hydrophilic via grafting of anhydride branches or acid treatment²⁷⁻²⁹. Wicking can thus be achieved within the narrow spaces between the PP fibers that form the PP line, or strand. To enhance its wicking capacity, PP cord were fabricated with multiple strands, for example woven together (see FIGS. 5A-5F, FIG. 11 and FIG. 12). Notably, the PP cords with more than two strands (e.g., 3T to 9T) feature inter-strand pores (see FIGS. 5C-5F and S11C-11I). These relatively large inter-strand pores efficiently conduct fluid within the core (i.e., within an outer surface of the strand and/or outer surface of the cord formed by two or more strands) (see FIG. 13), while the 1T strand without an inter-strand pore exhibited moderate wicking.

In addition to capillarity, rapid water evaporation at the surface of the crystallizer can be important to achieving sustained, high-rate capture. The PP lines provided a water evaporation rate of 0.81 kg/m²/hr (based on the cylindrical exterior area available for evaporation) which is 2.2-times higher than that achieved with a flat water surface (see FIG. 14). A high evaporation rate from the PP surface can be attributed to the hydrophilicity and geometry, continuously wicking water from the interior to the exterior surface, similar to evaporative cooling effects employed in technical apparel³⁰. The 1T and 3T lines, which had a high external surface area per cross-sectional area, exhibited the highest evaporation rates.

### High-Rate Capture Sustained

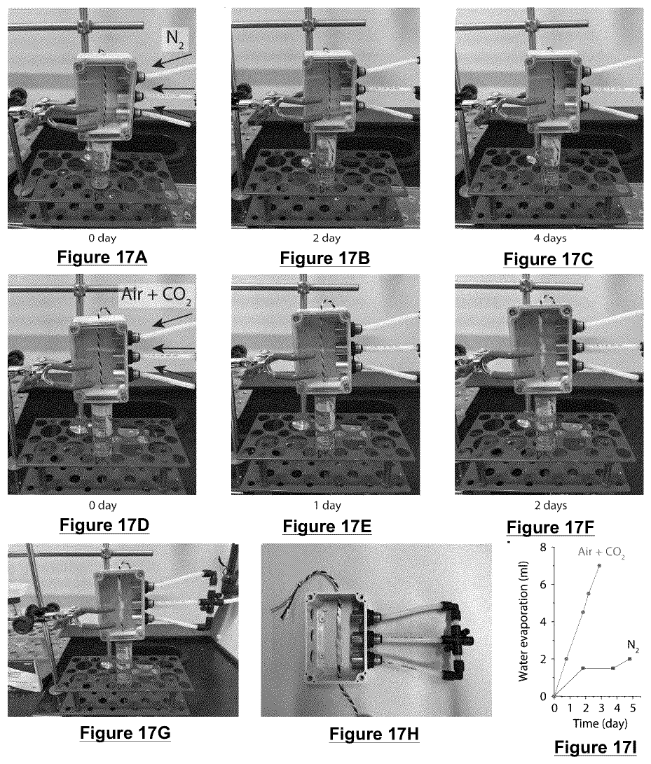

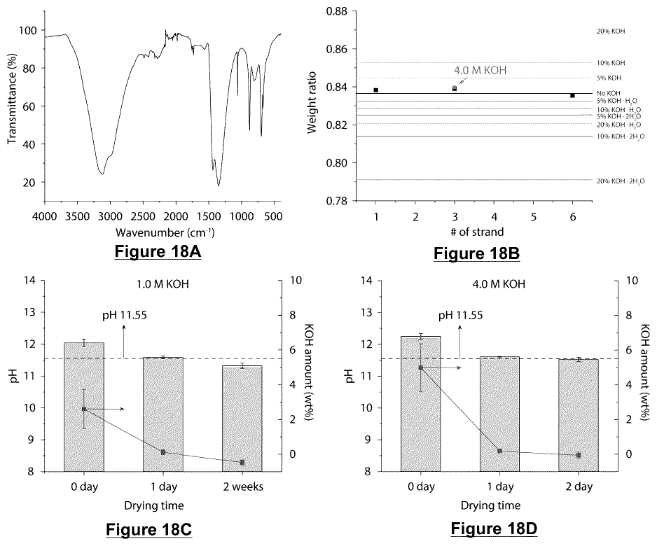

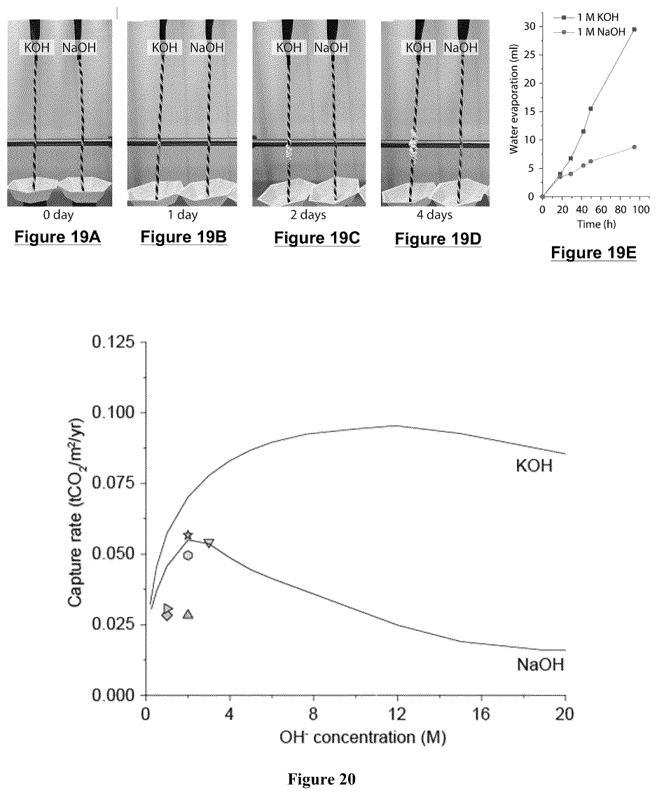

The inventors introduced an alkaline absorbent, 1.0 M KOH solution, to evaluate the capture performance of the PP crystallizers with different capillary pore structures. After 2 days, white precipitates formed at a specific height on each strand (see FIG. 5G), and this height corresponded roughly to where the KOH solution was sufficiently concentrated, as indicated by a separate test with pH indicator dye (H_{capill}. in FIG. 5H). Precipitates did not form when the experiment was conducted with a flow of N₂ (in the absence of CO₂) and the water evaporation rate decreased due to the concentration of KOH (see FIG. 17). Analysis with X-ray diffraction (XRD) (see FIG. 5I), Fourier-transform infrared spectroscopy (FT-IR), and other quantitative measurements (see FIG. 18) confirmed that the fully dried precipitates were K₂CO₃·1.5H₂O with a purity exceeding 99.5%. Trace amounts of KOH solution residues in the precipitates were transformed into solid K₂CO₃·1.5H₂O by drying the collected precipitates in ambient air (FIGS. 18C and 18D).

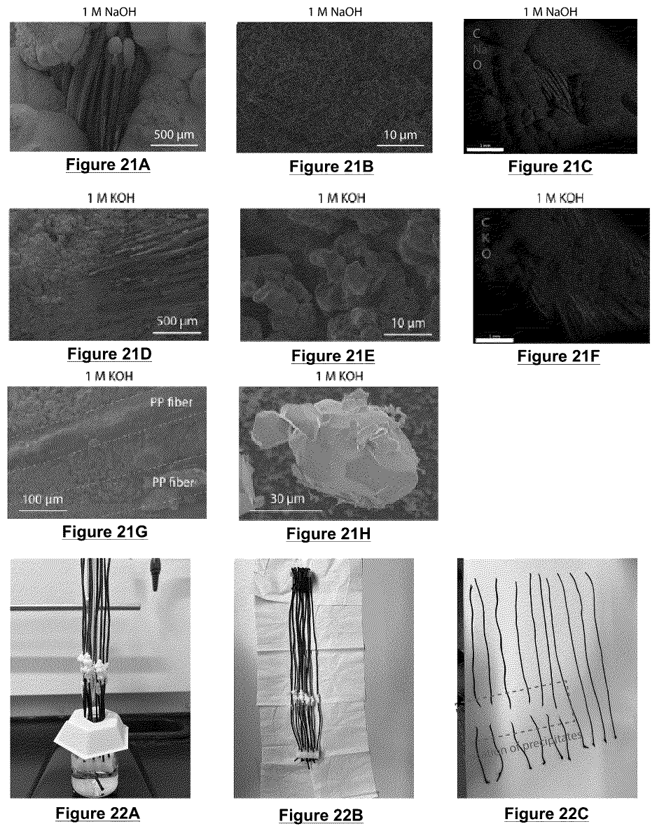

Using a 1.0 M NaOH solution in place of KOH resulted in minimal salt accumulation and a decreasing evaporation rate (see FIG. 19). The concentration of the NaOH solution after water evaporation did not achieve as high a capture rate as KOH (see FIG. 4A) while a dense Na₂CO₃ layer formed after capture inhibited capillary action (see FIG. 21). Under the same conditions, the K₂CO₃ precipitate layer, formed after CO₂ capture by the KOH solution, exhibited rapid and sustained growth (see FIG. 19). Scanning electron microscope (SEM) images of the precipitate layer revealed a porous structure consisting of micron-sized K₂CO₃ crystals (see FIG. 21) that provides a capillary pathway for KOH solution to reach the air interface.

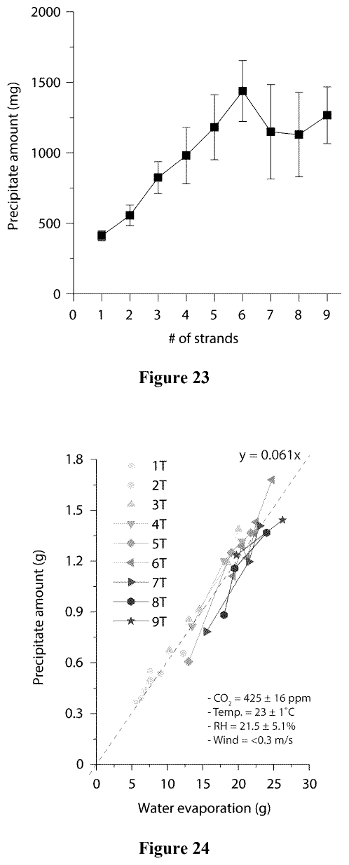

The capture rate of the crystallizers (tCO₂/m²/yr) was calculated using the mass of the precipitate (see FIG. 23), the duration required for formation, and the cross-sectional area of the crystallizers. It was posited that the capture rate of a crystallizer strand would depend on its water evaporate rate, which is proportional to the cylindrical area of the KOH solution exposed to the air (see FIG. 5H), πD_{cord}*H_{capill}. Two evaporation models were formulated to explain the capture rates: one for the 1T and 2T crystallizers without inter-strand pores (see FIG. 5J, red dashed line on the left) and another for the 3T to 9T crystallizers with inter-strand pores (see FIG. 5J, red dashed line on the right). The high capture rate of the 1T and 3T crystallizers was attributed to a larger surface area per unit cross-sectional area or per number of inter-strand pores.

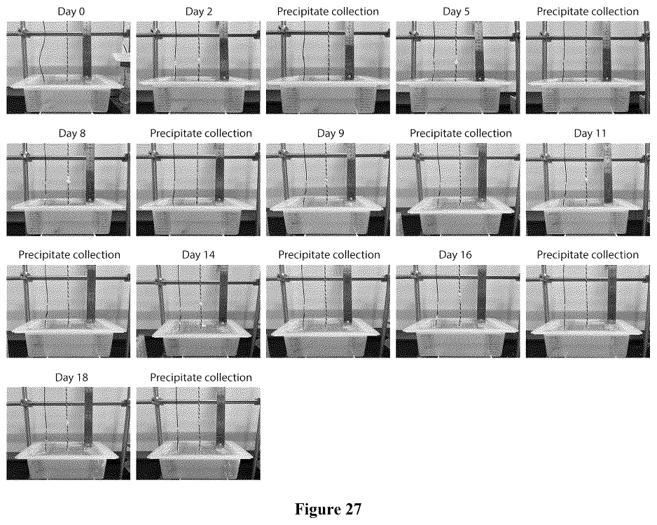

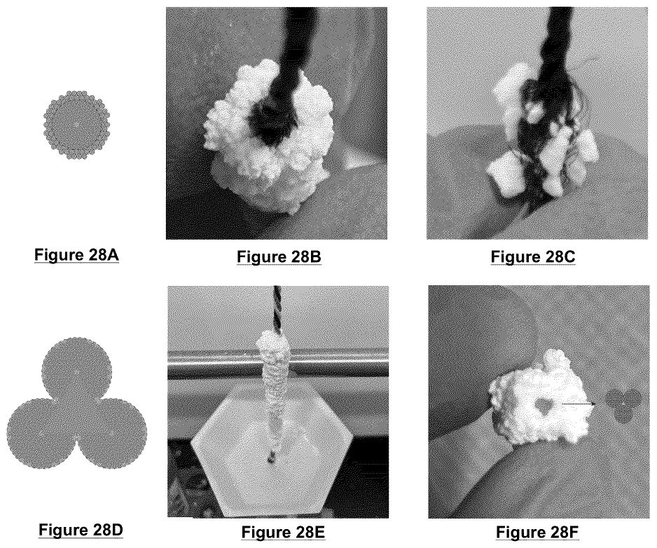

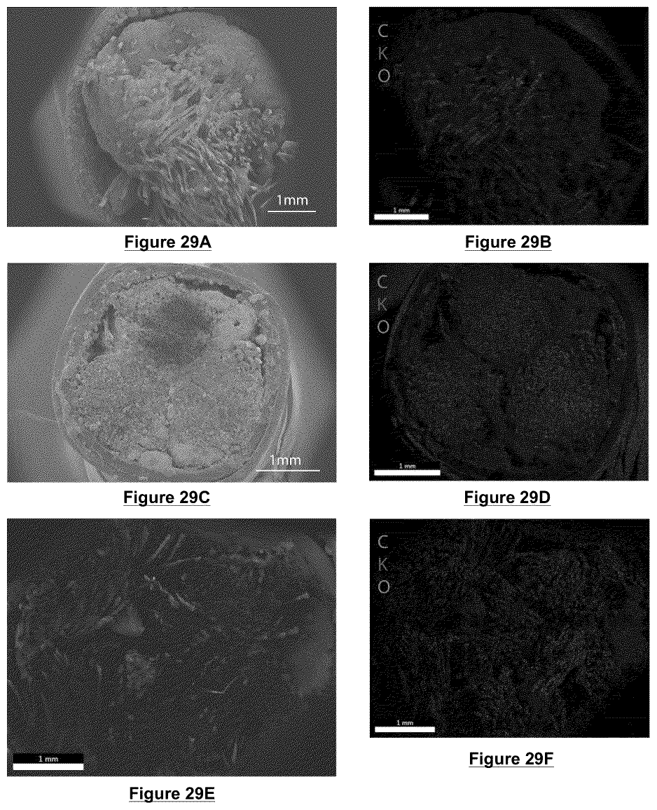

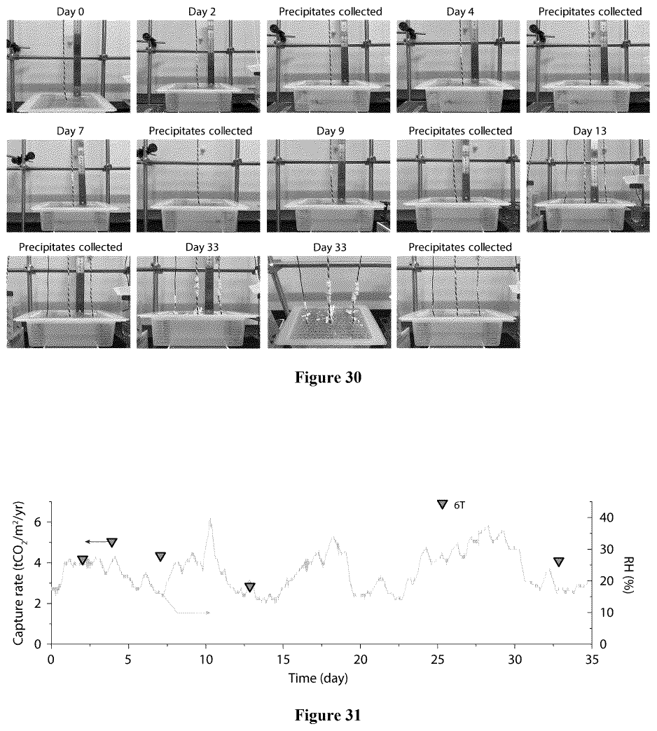

The reusability of the crystallizer lines were assessed over repeated carbonate growth and collection cycles. The 1T crystallizer exhibited a notable decrease in its capture rate after the first cycle (see FIG. 5K (squares) and FIG. 27), an effect attributed to carbonate formation within the thin PP fiber network leading to structural degradation (see FIGS. 28A-28C and FIGS. 29A-29B). In contrast, the 3T and 6T crystallizers maintained their structure and capture rates over multiple cycles of precipitation and removal over the course of weeks (see FIG. 5K (triangles) and FIGS. 27, 30 and 31). The inter-strand pores within these long-lived crystallizers may have kept the core of the PP crystallizers wet, and thereby maintained the evaporation front and precipitate growth at the outer surface. This preserved the integrity of the fiber structure (see FIGS. 28D-28F and FIGS. 29C-29F) and enabled consistent capture rate over many cycles.

The long-term test also showed the influence of relative humidity (RH) on the capture rate during the experiment. Specifically, the RH during Day 7 to Day 11 (see FIG. 5K, grey curve) was low (9.2%), resulting in a higher capture rate for the 3T crystallizer compared to normal days when the RH ranged between 20 and 30%. This increased capture rate is attributed to accelerated water evaporation under dry conditions. The high capture rate sustained over weeks without chemical looping is a departure from conventional air-liquid contactor dynamics, slowing over the course of hours.

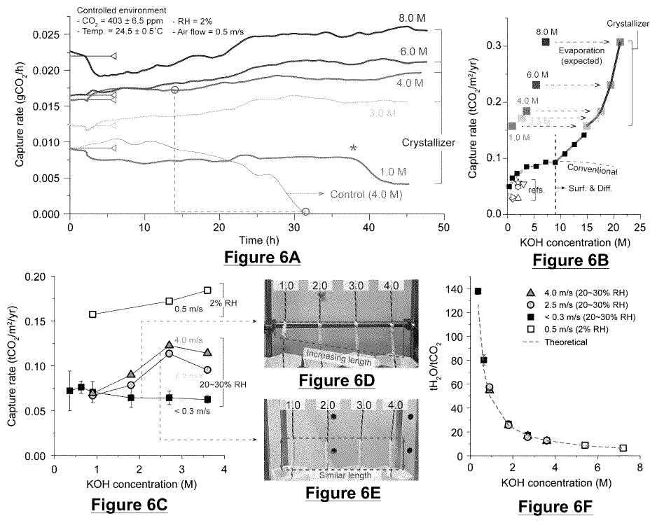

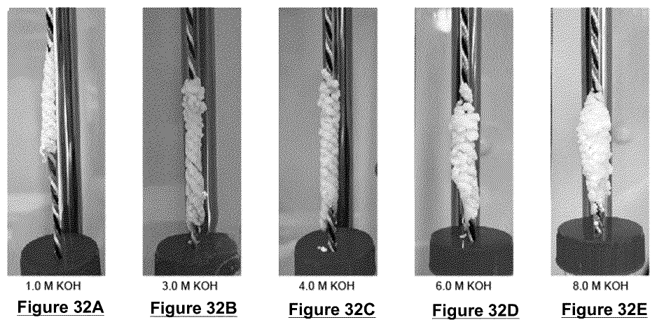

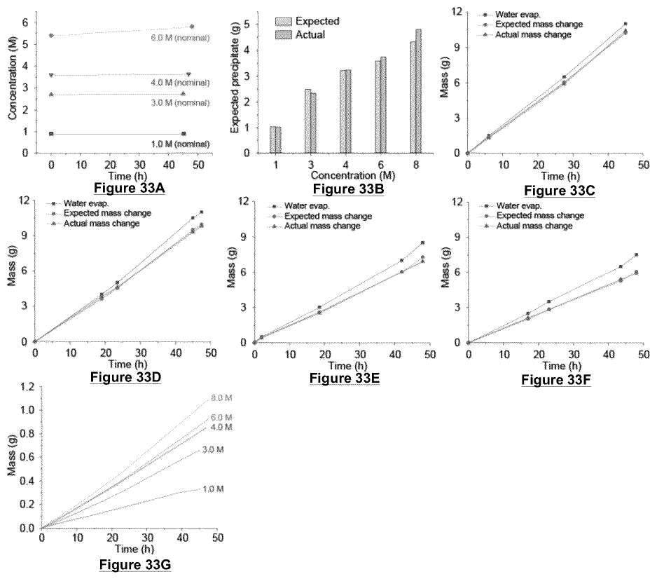

The capture rates of 3T crystallizers were measured in a controlled environment (2% RH, 405 ppm CO₂) using different concentrations of KOH solutions. The carbonate crystallizers exhibited sustained capture rates not only across multiple capture cycles but also within a single cycle during precipitate formation (“Crystallizer” in FIG. 6A). Using higher bulk KOH concentrations generally resulted in higher capture rates, and the capture rates even gradually increased over time due to the increased surface area accompanying growth of the precipitate layers (see FIG. 32). The crystallizer's ability to self-sustain capture rates is attributed to the high local [KOH]/[K₂CO₃] ratios at the air interface, maintained via continuous evaporation of water and solidification of carbonate. The bulk KOH concentration was constant throughout the capture experiment (see FIG. 33A).

In contrast, a control experiment where 300 sccm air was bubbled through a 4.0 M KOH solution showed a lower and declining capture rate over time (‘Control’ in FIG. 6A). This control system took 2.2 times longer to consume the entire KOH in the solution (red circles) and evaporated 2.3 times more water compared to the crystallizer.

The area-normalized capture rates of the crystallizer were calculated based on its initial capture rates before significant precipitate formation (triangles in FIG. 6A) and its surface area. The capture rates (colored squares in FIG. 6B) far surpassed those of conventional air contactors (“refs.” in FIG. 6B) and the theoretical capture rates calculated using a conventional capture mechanism (dashed curve in FIG. 6B). The capture rates of the crystallizer were x-shifted to match the trend of the capture rates in control experiments (dashed arrows in FIG. 6B).

The high capture rates achieved with the crystallizer can be attributed to high local [KOH]/[K₂CO₃] ratios, which result from the supersaturation of K₂CO₃ at the air interface facilitated by water evaporation and the common ion effect from the concentrated KOH. The supersaturation leads to the rapid local precipitation, with precipitation rate (or crystal growth rate) typically proportional to the nth power (typically 1 to 2) of the degree of supersaturation^{34,35}. This explains the continuous increase in the capture rate with concentration (“Crystallizer” in FIG. 6B), which would otherwise saturate at high KOH concentrations due to the reduced diffusivity of K₂CO₃ caused by the high ionic strength.

### Factors Affecting the Capture Rate of Crystallizers

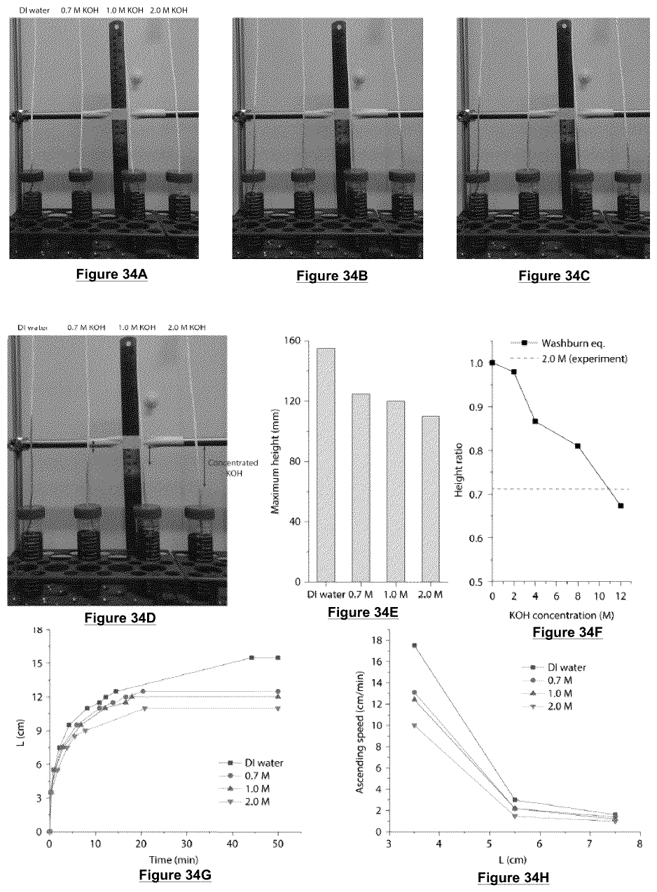

Next, the effects of relative humidity (RH) on the capture rate of the crystallizer were investigated. At high RH (20-30%), the area-normalized capture rates of the crystallizer (filled squares in FIG. 6C) decreased at low RH (open squares in FIG. 6C). Also, these rates were largely independent of the bulk KOH concentrations. This suggests that high RH limited the local KOH concentration at the crystallizer surface to below a certain level. More precipitates formed at high bulk KOH concentrations in greater absolute amounts because the extended area of the crystallizer had a local KOH concentration sufficient for capture, rather than due to an increase in local KOH concentration (FIG. 6D and FIG. 34).

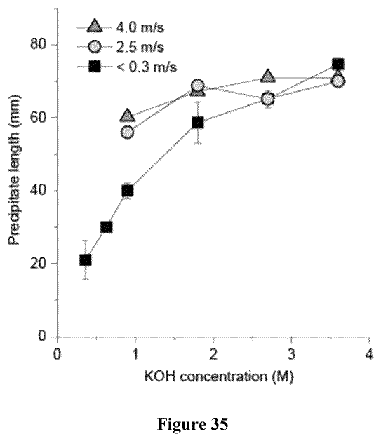

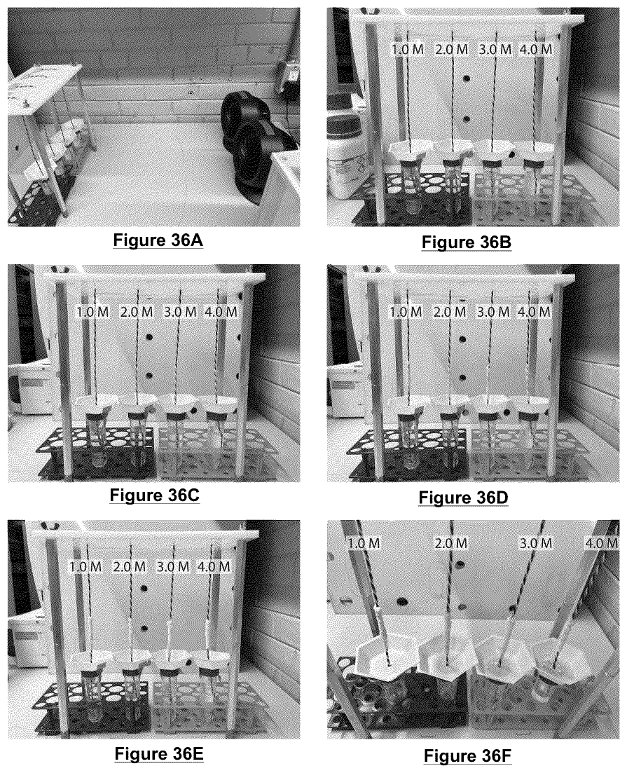

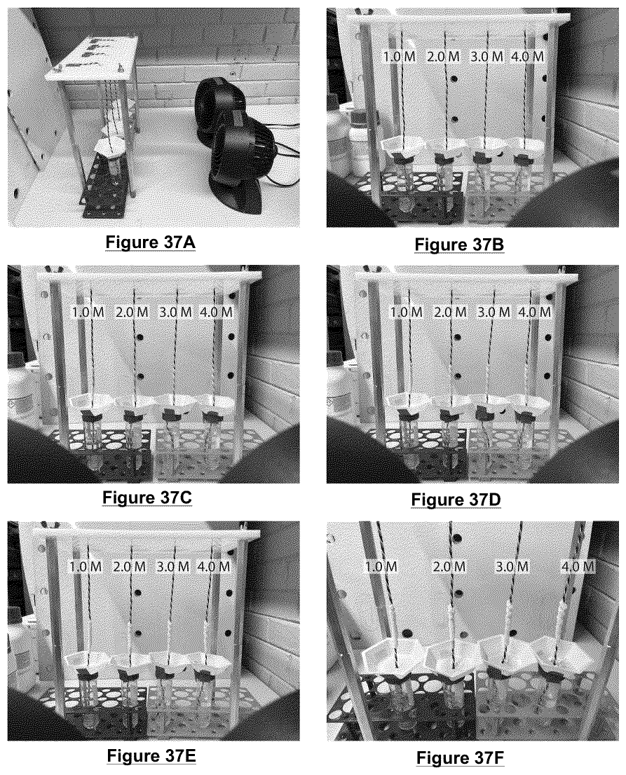

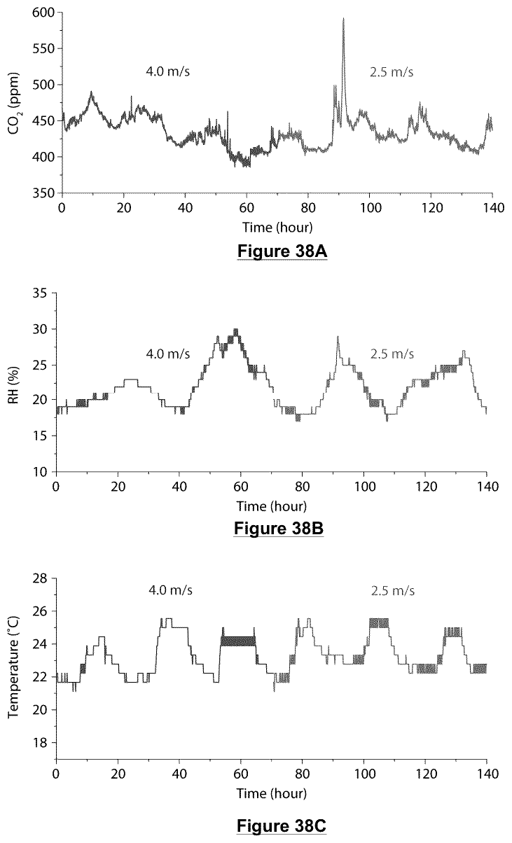

Likewise, applying air currents within the environmentally relevant range³⁶ with a 1.0 M KOH solution formed an extended area of the crystallizer active to capture (“1.0” in FIG. 6E), while exhibiting a similar area-normalized capture rate (FIG. 6C). However, with higher KOH concentrations, wind resulted in higher area-normalized capture rates (circles and triangles in FIG. 6C) without significant changes in precipitate lengths (FIG. 6E and FIGS. 35-39). These results suggest that air velocity has a more pronounced effect on the water evaporation rate at higher KOH concentrations.

Independent of the bulk KOH concentration, RH, and wind speed, two OH-ions are consumed to capture one CO₂ molecule (2KOH+CO₂→K₂CO₃+H₂O), with the water evaporating concurrently; the corresponding tH₂O/tCO₂ curve is plotted in FIG. 6F. This analysis aligns with the results of the capture experiments, where CO₂ capture and carbonate precipitation at the crystallizer surface occurred following water evaporation and concentration of KOH solution.

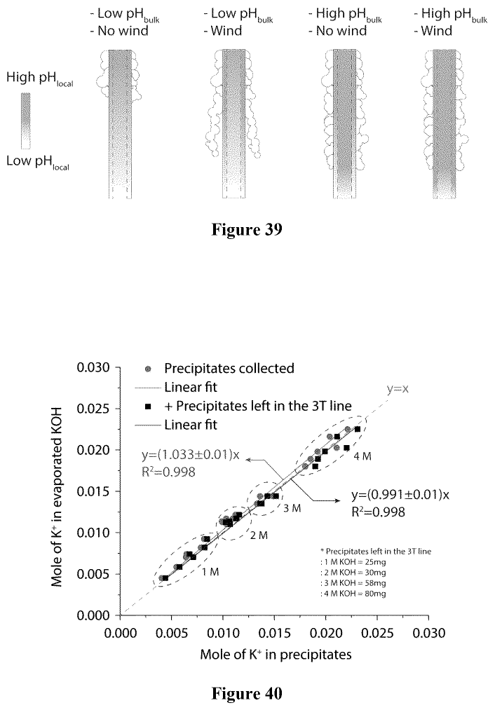

The combined potassium content in the collected carbonate precipitates and the portion trapped within the PP crystallizer corresponded almost exactly to the potassium quantity in the consumed KOH solution for capture (FIG. 40), demonstrating a near-complete transfer of potassium to carbonate precipitate, and negligible loss of potassium. To minimize the water consumption, 4.0 M KOH solution was chosen for further tests, yielding 12˜13 tH₂O/tCO₂ of water evaporation (FIG. 6F—comparable to the reported values for established air contactors^{4,37}.

### Scalability of Carbonate Crystallizer Direct Air Capture

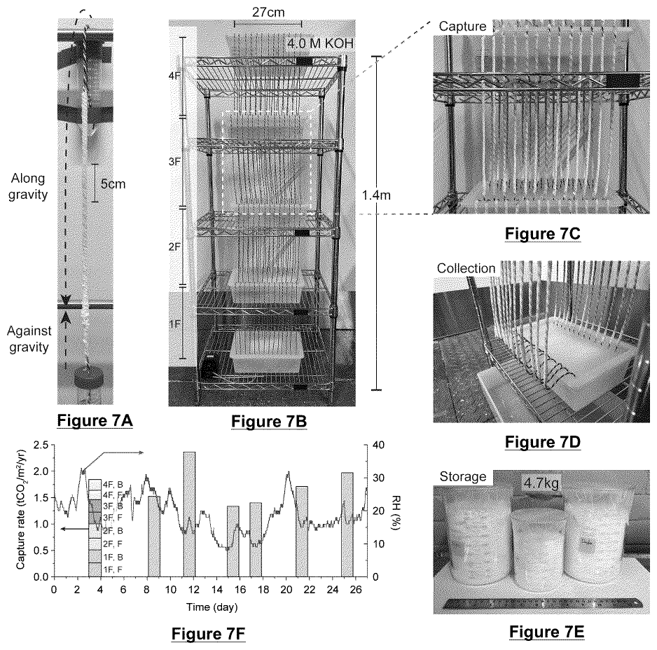

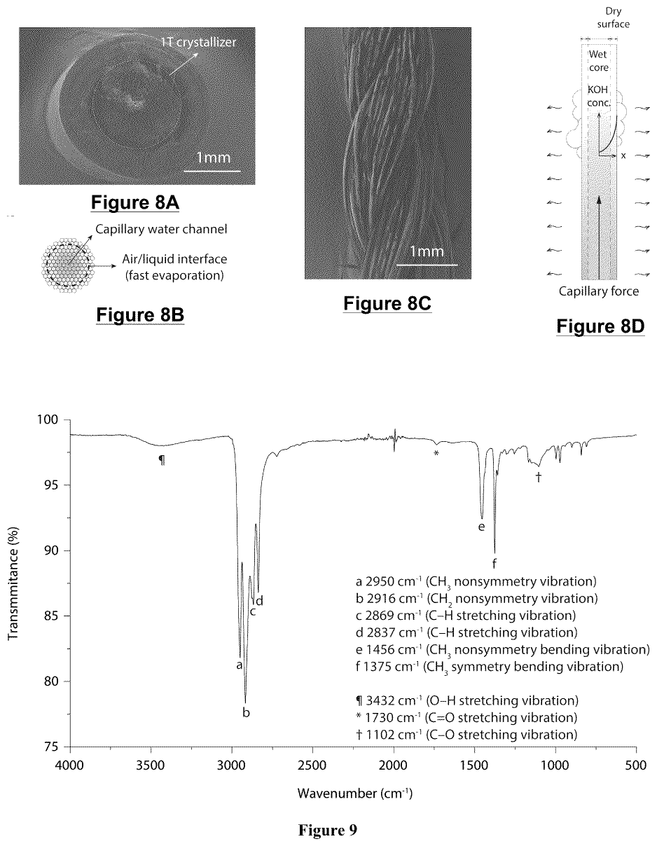

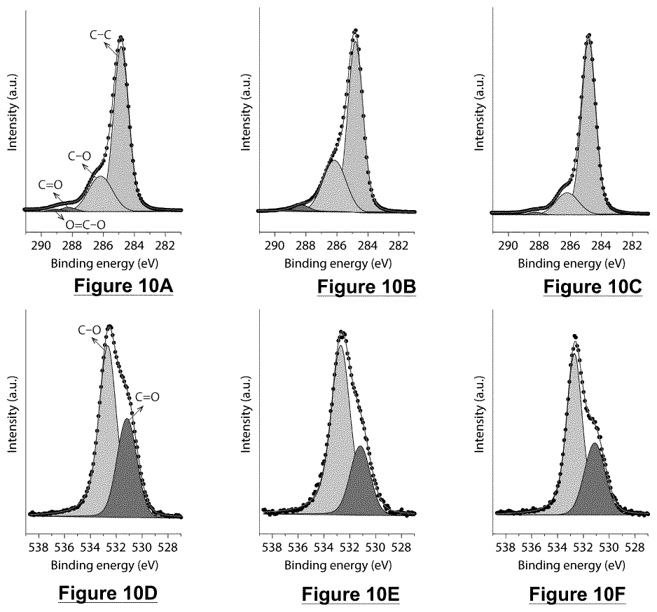

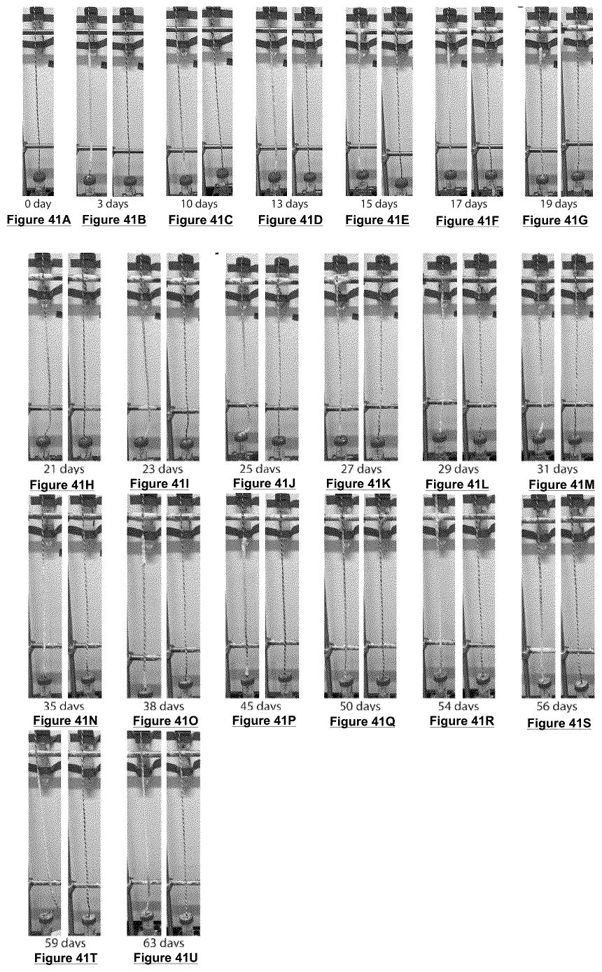

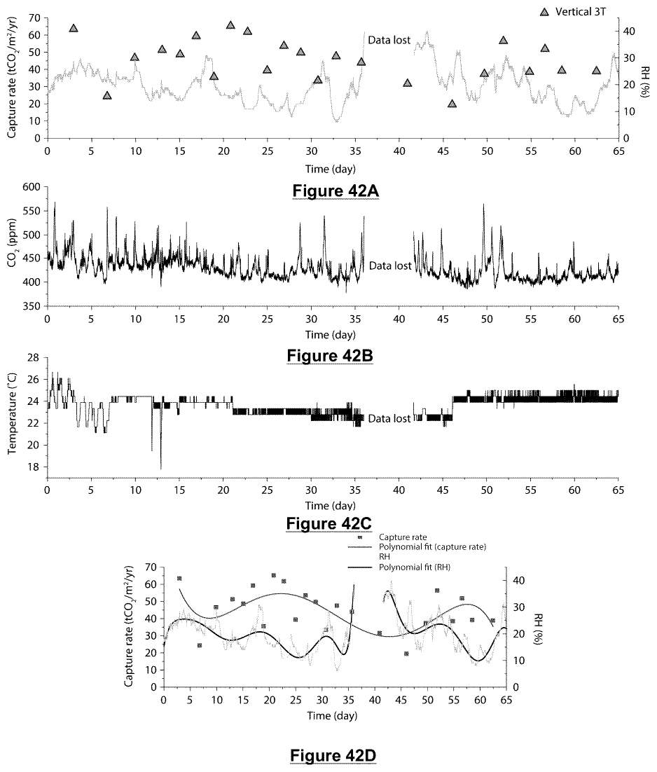

The inventors conducted a capture experiment using the 3T crystallizer unit, while introducing 4.0 M KOH solution from both top and bottom (FIG. 7A). This configuration led to a significantly expanded coverage of the KOH solution across the carbonate crystallizer surface, lever both gravitational and capillary forces (dashed arrows). Consequently, the capture rate and precipitate length were respectively 4.1- and 5.0-times higher than when the KOH solution was solely fed from the bottom through capillary action. Furthermore, this system maintained a stable capture rate over a span of two months (see FIGS. 41 and 42), with variations in capture rate attributed to fluctuations in relative humidity (see FIG. 42D).

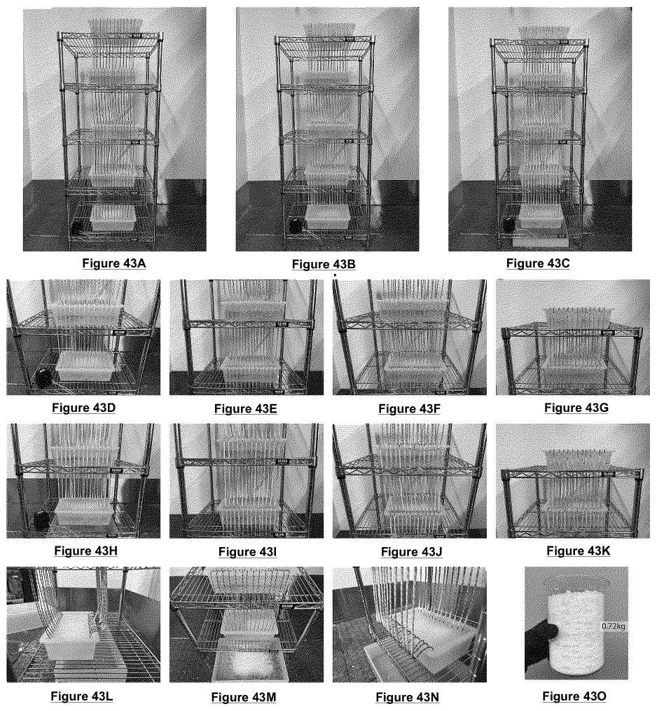

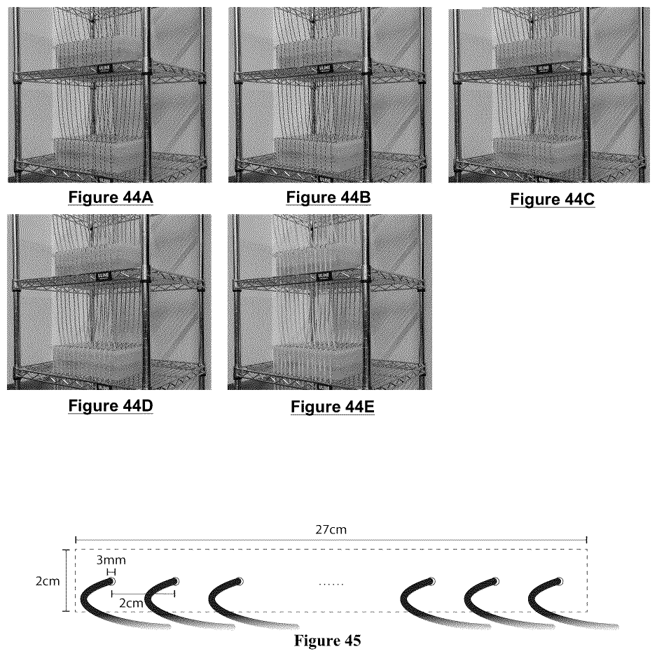

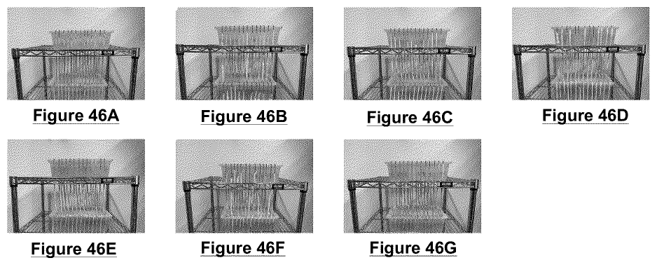

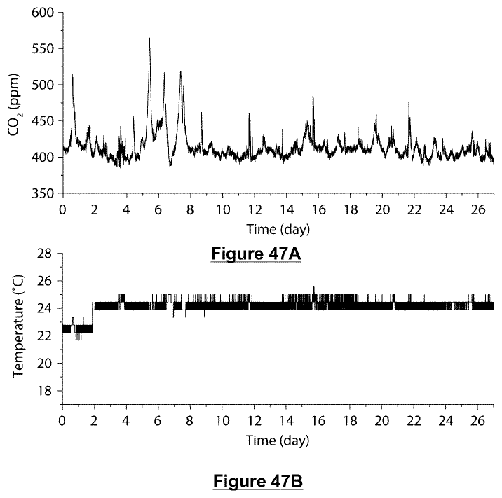

This vertical configuration is amenable to scaling. A model capture farm was constructed, with a trellis comprising arrays of 3T crystallizers stacked vertically across four layers (see FIG. 7B, with a total height of 1.4 m), and five 4.0 M KOH trays connecting neighbouring stacks. Each layer accommodated twenty-seven 3T crystallizers arranged in two rows. After 3.5 days, all 3T crystallizers yielded carbonate precipitates, totalling 0.72 kg (see FIGS. 7C, 7D, 43, and 44). The capture rate of the crystallizers on each level was calculated by normalizing the captured CO₂ amount by the installation area of the crystallizers (see FIG. 45)—instead of their cross-sectional area or surface area—for consideration of land use. All crystallizers across different floors and rows exhibited similar capture rates (Day 3.5 in FIG. 7F). Throughout the 25 days of continuous operation (and 7 harvest cycles), the capture farm maintained high capture rates, accumulating 4.7 kg of carbonate precipitate in total (see FIG. 7E). Overall, the capture farm demonstration provided a total capture rate of 1.74 tCO₂/m²/yr—1000 times the areal rate of carbon capture via biomass crops (see FIG. 48).

### Electrochemical Processing of Precipitates

To process the K₂CO₃·1.5H₂O precipitates, a three-compartment electrochemical cell was operated. The three-compartment electrochemical cell was designed to regenerate the KOH and release high-purity CO₂ for sequestration or utilization^{11,38-40}. The electrochemical cell employed the H₂-evolution reaction (HER) at the cathode electrode for KOH regeneration, coupled with H₂-oxidation reaction (HOR) occurring at the anode electrode for CO₂ release (see FIG. 49A).

The electrocatalysis cell regenerated a KOH solution at a concentration of 3.6 M and with a current efficiency of 88.6±0.021% (see FIGS. 49B and 49C). The amount of CO₂ released during these experiments closely corresponded to the molar amount of the K₂CO₃·1.5H₂O employed in the acidification chamber (see FIG. 49D). This electrochemical system represents one of the lowest energy costs among reported DAC systems operating at industrially-relevant current densities (100 mA/cm²).

With this regenerated KOH solution, three cycles of the DAC experiment were performed and it was found that the resulting capture rates and tH₂O/tCO₂ closely matched with those obtained with a synthetic 3.6 M KOH solution (see Figure S42(e)). These findings demonstrate the full K loop, including the capture by crystallizers, K₂CO₃ harvesting, CO₂ release, and the regeneration and reuse of KOH as delineated in FIG. 55.

The subject matter herein presents an approach to capture CO₂ directly into solid form, in a manner that is both high-rate and self-sustaining. High capture rate is achieved by evaporative concentration of the capture solution and this rate is sustained over weeks via in situ carbonate crystallization. When integrated, the resulting system is a major departure from conventional industrial air contacting—with carbonate crystallization more closely resembling an agricultural practice with cultivation, irrigation, and mechanical harvest (see FIG. 55A). In that capture farm model there is potential for DAC to leverage existing means already operating at Gt scale (agriculture represents the largest anthropogenic activity with respect to carbonaceous material flow, 2.7 gigatonnes of carbon or ˜10 GtCO₂)⁴¹ (see FIG. 55B). The self-sustaining nature of carbonate crystallization simplifies operation, removes a full solidification chemical loop, and it is estimated achieves a 10-fold reduction in capital requirement compared to the incumbent (see FIG. 55C), and a 1000-fold increase in areal carbon capture efficiency compared to biomass cultivation (see FIG. 48). Utilizing materials and processes already available at the scale required of DAC, this approach offers the potential to likewise expand decarbonization efforts in rate and scale.

### Crystallizer Setup

The base 1T polypropylene (PP) strand, with a diameter of 1.5 mm, was purchased from Amazon (JeogYong Co.). Variations of this line, ranging from the 2T to 9T PP lines, were crafted by weaving one to nine 1T base lines with different colors, white, brown, and black. The lines were then vertically affixed onto 50 ml centrifuge tubes using caps with holes of comparable thickness to the PP strands. Inside the tube, a PP strand was partially immersed in a KOH capture solution for wicking.

### Continuous Measurement of Crystallizer Capture Rate

The experiment was conducted in a large electronic box (7″×12″×14″), equipped with a weight balance (with a mass logging function) and a sensor recording CO₂ and humidity levels inside. The crystallizer setup was mounted on the balance, and air with a fixed RH (2%) and CO₂ concentration (403 ppm) was introduced through gas inlets towards the crystallizer. The amount of CO₂ captured by the crystallizers was measured by monitoring the mass change of the entire crystallizer setup continuously over time, which occurs due to water evaporation and CO₂ capture. The captured CO₂ amount was calculated using pre-determined ratios between the amounts of evaporated water and captured CO₂ (tH₂O/tCO₂) at different KOH concentrations (see FIG. 5F). This calculation method relies on the interdependence of the carbonate precipitation after capture and water evaporation; without capture and carbonate precipitation, the concentration of KOH solutions inhibits further water evaporation (see FIGS. 17I and 19E), and conversely, CO₂ capture and carbonate precipitation require the concentration of the KOH solutions through water evaporation. The expected mass change, calculated using the mass of evaporated water determined from the volume change of the capture solution and the expected amount of captured CO₂ (using the tH₂O/tCO₂ ratio), closely matched the actual mass change measured by the balance (see FIGS. 33C-33F). Furthermore, the mass of precipitates collected after the capture experiment closely matched the expected value (see FIG. 33B). The chemical formula K₂CO₃·1.5H₂O was used for the calculations due to the wet nature of the precipitates. The capture rate of the crystallizer was calculated as the first derivative of the amount of captured CO₂ over time (see FIG. 33G).

### Measurement of Crystallizer Capture Rate in Ambient Conditions

The capture rates of the crystallizers operated in ambient conditions (RH typically ranging from 20 to 30%) were measured based on the total amount of precipitates collected, the total capture period, and the active surface area of the crystallizer.

### Measurement of the Capture Rate of Conventional Capture System

A 300 sccm air flow (CO₂ concentration of 475 ppm) was bubbled through a 3 ml of 4.0 M KOH solution and the outlet gas was directed to a CO₂ analyzer (Teledyne T360M) to measure the change in CO₂ concentration. The capture rate was calculated using the change in CO₂ concentration and the flow rate of the outlet gas. To replenish water evaporation during the capture reaction, 1-1.5 ml of DI water was added to the capture solution multiple times. To measure the area-normalized capture rate, instead of bubbling air through the capture solution, air was blown over the surface of the capture solution in a larger vessel to minimize turbulent flow. A stirring bar was used to gently stir the capture solution. The area-normalized capture rate was calculated using the surface area of the capture solution.

### Electrodes for Electrocatalysis Cell

The cathode electrode for HER was prepared by spray-depositing a catalyst ink. The catalyst ink comprised 1.5 mg/ml of 60% platinum on Vulcan nanoparticles and 1 mg/ml of Nafion 1100W ionomer binder in a solution consisting of 60vol % IPA mixed with 40vol % DI water. The catalyst ink was deposited onto a hydrophilic carbon substrate (AvCarb MGL190). The mass loading of Pt nanoparticles on the electrode was adjusted to 0.8 mg/cm² (Pt only). Subsequently, the electrode was dried in the air overnight prior to experiments. For the anode electrode for HOR, a commercially available hydrophobic carbon electrode with 0.5 mg/cm² of 60% platinum on Vulcan was purchased from the Fuel Cell Store.

### Configuration of Electrocatalysis Cell

A custom-made three-compartment cell was used for all electrochemical operations. In the cathode compartment, a 1 cm×1 cm (1 cm²) cathode electrode was positioned and separated from the middle compartment by a cation exchange membrane (Nafion 115, 127 μm). Another cation exchange membrane separated the middle compartment from the anode compartment. An anode electrode was cut into 1 cm×1 cm (1 cm²) and installed onto the anode compartment. To prevent leakage, rubber gaskets were placed between the neighboring compartments.

### Electrocatalysis Cell Operation

All electrochemical tests were conducted under standard conditions at room temperature (˜293K) and atmospheric pressure (˜1 atm). All data presented in this study were obtained using cathode and anode electrodes with mass loading of 0.8 mg/cm² Pt and 0.3 mg/cm² Pt, respectively. All performance metrics were recorded after stabilization at a specific condition. The full-cell voltages reported in this work were not iR corrected. During the electrocatalysis cell operation, the cathode (HER) chamber was recirculated with a 20 ml of DI water at a flow rate of 10 ml/min while the anode (HOR) chamber was supplied with H₂ gas at a flow rate of 3 sccm. A gas-tight glass bottle equipped with four in/out channels (liquid inlet, liquid outlet, gas inlet, gas outlet) served as the reservoir for a carbonate solution. The liquid inlet and outlet were connected to the middle chamber of the electrocatalysis cell, recirculating a carbonate solution (20 ml of 2 M K₂CO₃+1 M KCl) at a flow rate of 10 ml/min. The electrocatalysis cell operated at a current density of −100 mA/cm² using a potentiostat (Autolab PGSTAT204).

### Product Analysis (Capture Solution and CO₂ Release)

The pH of the capture solution generated from the HER chamber was recorded by a pH meter immersed in the solution (Hanna HI2020 edge Multiparameter pH Meter). Also, a flow of 15 sccm N₂ was introduced to the gas inlet of the carbonate solution reservoir, ensuring efficient purging of the CO₂ released from the solution. The gas outlet was connected to a flowmeter (Honeywell AWM3300V) to quantify the amount of CO₂ released during the cell operation. The standard curve used for quantification is provided in FIG. 54.

### Fourier-Transform Infrared Spectroscopy (FTIR)

The 3T PP cord was analyzed with an FTIR spectrometer (Perkin Elmer Spectrum Two with ATR accessory). The spectra range was set from 500 to 4000 cm⁻¹. All spectra were obtained using 4 cm⁻¹ resolution and 10 scans at room temperature.

### Materials Characterization

Scanning electron microscopy (SEM) imaging was conducted on a Hitachi FE-SEM SU5000 microscope operated at 30 kV. X-ray diffraction (XRD) analysis was performed on a MiniFlex600 system employing Cu Kα radiation. X-ray photoelectron spectroscopy (XPS) measurements were conducted using a Thermo Fisher Scientific K-Alpha XPS, equipped with a 1486.6 eV monochromated Al Kα X-ray source.
Self-sustained high capture rates of crystallizers enabled by continuous K₂CO₃ precipitation

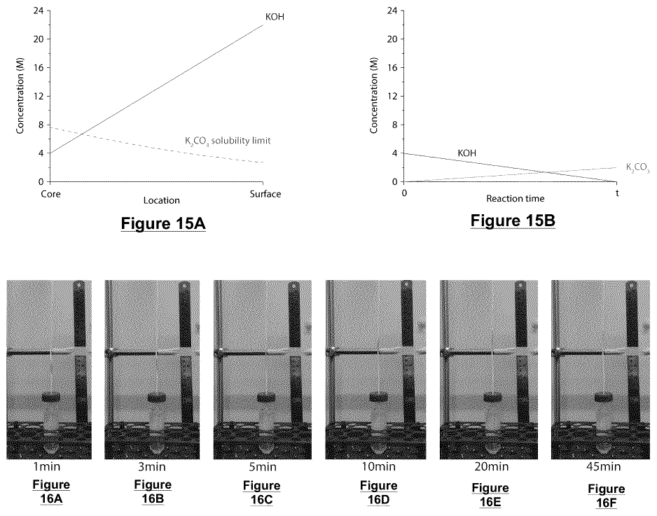

The carbonate crystallizers of the present teachings can efficiently capture CO₂ while simultaneously precipitating the formed K₂CO₃ in solid form at the surface. This is facilitated by the minimal water content at the surface and the common ion effect by the presence of the concentrated KOH solution. The presence of substantial amount of K⁺ ions at the surface, potentially reaching 22 M (the theoretical solubility limit of KOH, FIG. 15A), further facilitates the precipitation of K₂CO₃ at concentrations lower than its theoretical solubility limit. This phase separation of K₂CO₃ induces a higher local concentration of KOH compared to K₂CO₃ at the crystallizer surface. In contrast, in conventional air contactors using bulk KOH solutions directly for CO₂ capture, the concentration of KOH in the capture solution gradually decreases while that of K₂CO₃ increases, resulting in a gradual decline in the capture rate: 2KOH+CO₂→K₂CO₃+H₂O (see FIG. 15B).

In addition to the limited solubility of K₂CO₃, the predominant advection-driven flow of the bulk KOH solution along the crystallizer also contributes to the continuous precipitation of K₂CO₃. The ions at the crystallizer surface can hardly diffuse into the bulk KOH solution against the advection-driven flow induced by the rapid water evaporation from the crystallizer's surface (see FIG. 16)^{S12}. This process closely resembles the way plants transport nutrients from roots, through stems, to leaves via transpiration on the leaf surface.
Theoretical capture rates of liquid absorbents and a comparison between the conventional air contactor and crystallizer

Theoretical capture rates of KOH and NaOH solutions at different concentrations were calculated based on the method by Stolaroff et al^{S13}. Under the assumption of a stagnant film of alkaline solutions and steady-state conditions, the CO₂ capture rate or flux from the air to the solution can be expressed as:

$$\frac{\partial C}{\partial t} = D \frac{{\partial }^{2} C}{\partial {x}^{2}} - k \{ {OH}^{-} \} C = 0$$

$${J}_{{CO}_{2}} ( x ) = {C}_{0} {K}_{H} \sqrt{Dk \{ {OH}^{-} \}} exp ( - \sqrt{\frac{k \{ {OH}^{-} \}}{D}} x )$$

$${J}_{{CO}_{2}} ( x = 0 ) = {C}_{0} {K}_{H} \sqrt{Dk \{ {OH}^{-} \}}$$

$$L = \sqrt{\frac{D}{k \{ {OH}^{-} \}}}$$

(C═CO₂ concentration in the solution; x=Depth axis within the solution; k=Steady-state rate constant in a dilute solution; {OH⁻}=activity of alkaline solutions; C₀=CO₂ concentration in the air; K_{H}=Solubility of CO₂; D=Diffusivity of CO₂ in the solution; L=Specific diffusion length)

The parameters in the equation are involved in each step of the CO₂ capture process by liquid absorbents as follows:

$$Dissolution of {CO}_{2} : {CO}_{2 , ( g )} \to {CO}_{2 , ( aq )} ( {C}_{0} {K}_{H} ) . \qquad 1$$

$$Diffusion of {CO}_{2} : {CO}_{2 , ( aq )} \to {CO}_{2 , ( aq )} ( D ) . \qquad 2$$

$$Reaction with {OH}^{-} : {CO}_{2 , ( aq )} + {OH}_{( aq )}^{-} \to {HCO}_{3 , ( aq )}^{-} ( k \{ {OH}^{-} \} ) . \qquad 3$$

Since Henry's constant, diffusivity of CO₂, and activity of OH⁻ change with the concentration of OH⁻, the equation can be rewritten as follows:

$${J}_{{CO}_{2}} = {C}_{0} \frac{{K}_{H}^{0}}{{γ}_{{CO}_{2}}} \sqrt{\frac{{D}^{0}}{{μ}^{1.4}} k {γ}_{MOH} [ {OH}^{-} ]}$$

$${K}_{H}^{0}$$

=Henry's constant in a dilute solution^{S13,S14}; D⁰=Diffusivity in a dilute solution^{S15}; μ=Viscosity of the solution^{S16,S17}; γ_{MOH}=Activity coefficients^{S18} of KOH or NaOH; [OH⁻]=Concentration of OH⁻ ions)

The equations explaining the relationship between the coefficients and the concentration of MOH were either directly obtained from the references or derived by plotting the data values in them. Also, the equation explaining the inverse relationship between the diffusivity of CO₂ in alkaline solutions and the viscosity of the solutions was used^{S13,S15}. The resulting CO₂ diffusivities matched well with reported values in the literature^{S13,S19}. The resulting theoretical capture rates of KOH and NaOH solutions are plotted in FIG. 4A and FIG. 20. The NaOH capture solution exhibiting its theoretical maximum capture rate at 2 M aligns with literature reports indicating its optimal performance occurs within the 2 to 3 M range^{S9,S19}. The capture rates of conventional air contactors were calculated using the reported mass transfer coefficients^{S6}.

The areal capture rate of crystallizer was calculated using the initial capture rate of the crystallizer before noticeable amount of precipitates formed and normalizing it with the surface area of the crystallizer. The initial capture rate was used because calculating the surface area of rough and wet precipitate layer is difficult. The experimental details on the continuous measurement of the crystallizer capture rate are available in the Methods section. Then, to determine the interfacial area between the capture solution and air, the cross sections of the solution/air interface were assumed to be as shown in FIG. 25U. A smooth interface was assumed because the crystallizer surface was wetted by the capture solution. The resulting perimeter was then multiplied by the height of the capture-active region of the crystallizer, assumed to be same as the length of the precipitates. The resulting interfacial area was further adjusted by dividing it by the sine of the twist angle of the 3T crystallizer (˜70°) and used for the areal normalization of the capture rate. The resulting area-normalized capture rates of the crystallizer are plotted in FIG. 6B.

In FIG. 6B, the x-axis of the data points of the crystallizer shifted by 11 M (“Evaporation”), based on our expectation that the local KOH concentration at the crystallizer surface exceeded 12 M. This assumption is supported by our observations that the crystallizer could not wick 12 M KOH solution effectively due to the solution's high surface tension. Consequently, there is a maximum height along the crystallizer to which the KOH solution can ascend as it thickens up to ˜12 M after water evaporation (see FIG. 34). The fact that the amount of carbonates formed at lower heights of the crystallizer was similar to those formed at the maximum height implies that the local KOH concentration at the capture-active crystallizer surface was >12 M. The KOH concentration at the core of the crystallizer is expected to be 12 M or below.

### Effects of Pore Structure on the Capture Rate

The amount of carbonate precipitates formed on the PP lines correlates directly with the extent of water evaporation (see FIG. 24). Therefore, the capture rate should directly correlate with the rate of evaporation. Since identical materials for the various PP crystallizers were employed, their different capture rates can be attributed to their different active evaporation areas, which are determined by their weave structure or capillary force.

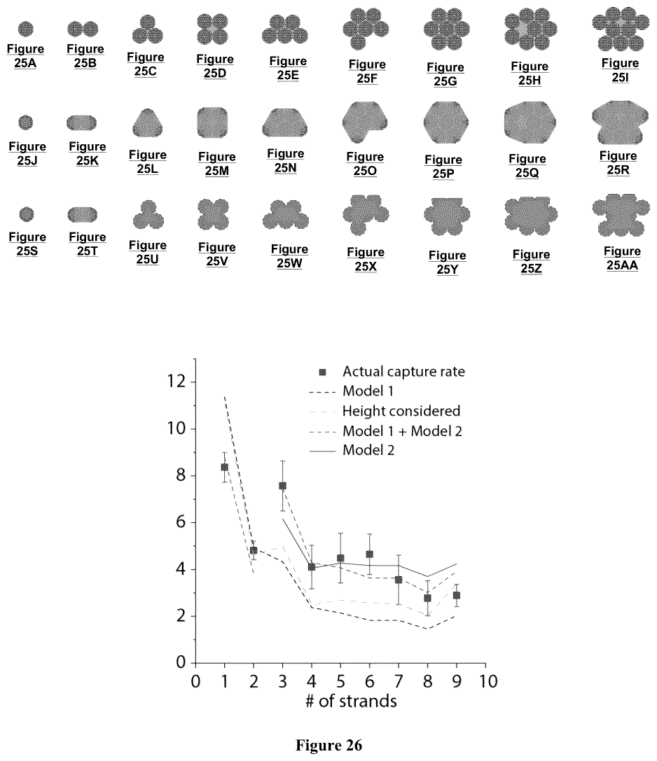

It was first noted that the evaporation rate of the 2T crystallizer was approximately half that of the 1T crystallizer, despite having a surface area twice as large (see FIG. 26). This suggests that the surface area of the 2T crystallizer where evaporation occurred is nearly equivalent to that of the 1T crystallizer because the capture rate is normalized by the cross-section area of the crystallizer. The inventors posited that the area between the two PP strands of the 2T crystallizer was fully wet, thus exhibiting a slower evaporation rate (grey colored region in FIG. 25K). Hence, it was hypothesized that water evaporation mainly occurred from the remaining surface of the 2T crystallizer where the porous PP fiber network facilitates rapid water evaporation and wicking (dashed semicircles in FIG. 25K). A smaller radius was assumed for the evaporation front than that of the PP strand (blue colored region in FIG. 25J and FIG. 25K) because the carbonate precipitation, expected to occur near the evaporation front, took place within the 1T strand (FIGS. 28 and 29). The inventors applied the same method to calculate the evaporation surface area of various PP crystallizers (FIGS. 25J-25R) and derived their predicted capture rate by normalizing the evaporation area with the cross-sectional area:

$$Predicted capture rate = C \times normalized evaporation area ( C = const . )$$

| | Actual capture | | | |
|---|---|---|---|---|
| | rate (tCO₂/m²/yr, | Cross-sectional | Evap. | Normalized evap. |
| Model 1 | Rₙ) | area (mm²) | area | area (Aₙ) |
| 1T | 8.37 | 1.77 | 1 | 0.567 |
| 2T | 4.81 | 4.08 | 1 | 0.245 |
| 3T | 7.57 | 4.64 | 1 | 0.216 |
| 4T | 4.10 | 8.47 | 1 | 0.118 |
| 5T | 4.49 | 9.38 | 1 | 0.107 |
| 6T | 4.65 | 11.0 | 1 | 0.0910 |
| 7T | 3.55 | 11.0 | 1 | 0.0910 |
| 8T | 2.77 | 13.8 | 1 | 0.0723 |
| 9T | 2.89 | 14.8 | 1.5 | 0.101 |

The total circumference of the dashed circles in FIGS. 25J-25R, representing the evaporation areas of the crystallizers, was normalized by that of the 1T crystallizer, which was set as unity. Then, the constant C was determined by solving the below equation:

$${min}_{C} J ( C ) , J = {\sum }_{n = 1}^{9} {( {R}_{n} - {C A}_{n} )}^{2}$$

(Rₙ: actual capture rate, Aₙ=normalized evaporation area of Model 1)

This approach yielded the following predicted capture rates:

| | Actual capture rate | Fitting (Model 1) |
|---|---|---|
| Model 1 | (tCO₂/m²/yr, Rₙ) | (tCO₂/m²/yr) |
| 1T | 8.37 | 11.4 |
| 2T | 4.81 | 4.93 |
| 3T | 7.57 | 4.33 |
| 4T | 4.10 | 2.37 |
| 5T | 4.49 | 2.14 |
| 6T | 4.65 | 1.83 |
| 7T | 3.55 | 1.83 |
| 8T | 2.77 | 1.45 |
| 9T | 2.89 | 2.03 |

$$C = 20.1 ( Model 1 )$$

The dashed black line in FIG. 26 represents the resulting prediction curve. This resulting curve failed to explain the capture rates of the crystallizers. Even after accounting for the different precipitate heights of the crystallizers (FIG. 5J), which account for extended evaporation surface of the 3T to 9T crystallizers, the resulting curve did not align with their capture rates (grey dashed line in FIG. 26).

This led to the hypothesis that 3T to 9T crystallizers exhibit different morphologies of evaporation-active air/liquid interface attributed to the presence of additional capillary pores (inter-strand pores). It was speculated that these inter-strand pores facilitate an extended air/liquid interface (FIGS. 25U-25AA) with a stronger capillary force, pushing the evaporation front towards the surface of the crystallizer (dashed circles). It is believed that this air/liquid interface on the 3T to 9T crystallizers also altered the location where carbonate precipitation occurred (FIGS. 28 and 29), contributing to their impressive reusability during multiple carbonate harvesting processes (FIG. 5K). Hence, additional constant, C′, was included to describe the contribution from the inter-strand pore-induced evaporation surface as follows:

$$Predicted capture rate = C \times normalized evaporation surface ( Model 1 ) + {C}^{′} \times n ormalized evaporation surface ( Model 2 )$$

$$( C , {C}^{′} = const . )$$

| | Actual capture rate | Cross-sectional | Evap. | Normalized evap. |
|---|---|---|---|---|
| Model 2 | (tCO₂/m²/yr, Rₙ) | area (mm²) | area | area (Aₙ′) |
| 1T | 8.37 | 1.77 | 1 | 0.566 |
| 2T | 4.81 | 4.08 | 1 | 0.245 |
| 3T | 7.57 | 4.64 | 2.5 | 0.539 |
| 4T | 4.10 | 8.47 | 3 | 0.354 |
| 5T | 4.49 | 9.38 | 3.5 | 0.373 |
| 6T | 4.65 | 11.0 | 4 | 0.364 |
| 7T | 3.55 | 11.0 | 4 | 0.364 |
| 8T | 2.77 | 13.8 | 4.47 | 0.323 |
| 9T | 2.89 | 14.8 | 5.5 | 0.370 |

The exact unit of the evaporation area or normalized evaporation area of the crystallizers was not considered since it would be automatically scaled during the process of solving the below equations to find C and C′:

$${min}_{C , C ′} J ( C , {C}^{′} ) , J = {\sum }_{n = 3}^{9} {( {R}_{n} - {C A}_{n} - {C}^{′} {A}_{n}^{′} )}^{2}$$

(Rₙ: actual capture rate, Aₙ=normalized evaporation area determined by Model 1, Aₙ′=normalized evaporation area determined by Model 2)

The summation starts from n=3, and both Model 1 and 2 are used. Only Model 1 was used to fit the capture rate of the 1T and 2T crystallizers:

$${min}_{C} J ( C ) , J = {\sum }_{n = 1}^{2} {( {R}_{n} - {C A}_{n} )}^{2}$$

This approach yielded the following predicted capture rates:

| | Actual capture rate | Fitting (Model 1) | Fitting (Model 1 + 2) |
|---|---|---|---|
| Model 1 + 2 | (tCO₂/m²/yr, Rₙ) | (tCO₂/m²/yr) | (tCO₂/m²/yr) |
| 1T | 8.37 | 8.80 | |
| 2T | 4.81 | 3.81 | |
| 3T | 7.57 | | 7.46 |
| 4T | 4.10 | | 4.30 |
| 5T | 4.49 | | 4.07 |
| 6T | 4.65 | | 3.64 |
| 7T | 3.55 | | 3.64 |
| 8T | 2.77 | | 3.01 |
| 9T | 2.89 | | 3.92 |

C=15.6 (Model 1 for 1T and 2T); C=25.7, C′=3.57 (Model 1±2 for 3T to 9T)

The resulting prediction curves closely matched the observed capture rate (red dashed lines in FIG. 26). Considering the contribution solely from the evaporation surface of Model 2 did not yield a well-fitted curve (blue line in FIG. 26).

Concentration of KOH Solutions within the Crystallizer

A capillary experiment was performed using an organic compound, Rhodamine B, which can dye a white PP crystallizer to monitor the thickening of the KOH capture solution within the capillary pores. 10 mg of Rhodamine B was dissolved in DI water, as well as 0.7, 1.0, and 2.0 M KOH solutions. The amount of Rhodamine B in the 2.0 M KOH solution was close to its solubility limit, likely due to the high ionic strength of the solution. This amount of Rhodamine B was chosen to monitor any color changes in the solution as it concentrates while ascending along the crystallizer and experiencing water evaporation. If KOH concentration occurs, the solubility of Rhodamine B would decrease, resulting in fading color in regions where the KOH solution is concentrated.

FIGS. 34A-34d show the results of this experiment. A clear weakening of the Rhodamine B color was observed over time as water evaporated from the KOH solutions ascending the white 3T crystallizer. This indicates a concentration of the KOH solution and a resulting decrease in the dye's solubility (arrows in FIG. 34D). It is also noteworthy that the length of this region widened at higher KOH concentrations, roughly matching the length of precipitates formed at corresponding KOH concentration (FIG. 6D). Furthermore, it was observed that the different KOH solutions reached similar maximum heights, all of which were lower than that of DI water. These maximum heights also corresponded to those of carbonate precipitates formed at corresponding KOH concentrations (FIG. 6D). According to the Washburn equation, and considering the dynamic viscosity^{S17} and surface tension^{S20}, a 2.0 M KOH solution is expected to ascend the crystallizer to a similar height as DI water with only a 2% difference (FIG. 34F):

$$L = \sqrt{\frac{γ rt cos ( φ )}{2 μ}}$$

(L: penetration distance, μ: dynamic viscosity of the liquid, γ: surface tension of the liquid, r: pore radius of the capillary, t: time, φ: contact angle between the liquid and solid)

However, the observed height difference between them was approximately 29% (indicated by the dashed line in FIG. 34F). This was attributed to two possibilities: the KOH solution becoming highly concentrated at the highest height after undergoing water evaporation, resulting in either 1) high viscosity or 2) high surface tension. The Washburn equation predicts that the dynamic viscosity of a 12 M KOH solution would exhibit a similar capillary rise to what was observed from the 2.0 M KOH (the dashed line in FIG. 34F). Another possibility is that the wetting angle of the KOH solution became larger than 90° (φ>90°) with an increase in its surface tension. This will make cos(φ)<0 in the Washburn equation, leading to the pinning the KOH solution at the highest height. Although the Washburn equation cannot give us a precise quantitative explanation since it does not account for water evaporation and the resulting varying concentration of KOH solution along the crystallizer surface, it still provides qualitative evidence of the thickening of the KOH solution within the crystallizer.

### Electro-Osmotic Water Drag Caused by the Transport of K⁻

The electro-osmotic water drag caused by the transport of K⁺ through a cation-exchange membrane (CEM) can be quantified by its electro-osmotic coefficient as follows:

$${K}_{drag} ( {C}^{+} ) = \frac{n ( {( {H}_{2} O )}_{drag} )}{n ( {C}^{+} )}$$

This equation suggests that if the electro-osmotic coefficient of the C⁺ ion is x, then one C⁺ ion carries x H₂O molecules. The electro-osmotic coefficient of K⁺ through Nafion typically falls in the range of 2 to 4. Assuming two or four water molecules are dragged by one K⁺ ion, the amount of water crossed over for 25.5 h is calculated as following:

$${2}^{*} {0.1}^{*} 91800 / {96485}^{*} 18 = 3.43 g ( ml ) of water$$

$${4}^{*} {0.1}^{*} 91800 / {96485}^{*} 18 = 6.85 g ( ml ) of water$$

This matches well with the observed increase in the solution volume (3.7±0.6 ml) after 25.5 h of electrolysis (91800s) at 100 mA.

### Current Efficiency Analysis

The Faraday's law was used to calculate the theoretical hydroxide production rate (r_{OH}_{^{−}}) in the capture solution as follows:

$${r}_{{OH}^{-}} = \frac{{I}_{cell}}{nF}$$

Where I_{cell} represents the applied current density of the electrocatalysis cell, n is the number of electrons transferred per hydroxide ion generated (=1), F is the Faraday's constant (96485 s·A/mol). The real-time current efficiency (CE) of electrocatalysis configuration was calculated as follows:

$$C E = \frac{{C}_{{OH}^{-} , exp}}{{C}_{{OH}^{-} , theoretical}}$$

C_{OH}_{^{−}}_{,exp} represents the hydroxide concentration measured by a pH meter (FIG. 50). C_{OH}_{^{−}}_{,theoretical} is the product of r_{OH}_{^{−}} and time (s). The observed final pH being lower than the theoretical value (assuming 100% current efficiency) was attributed to two factors: firstly, electroosmotic drag of water due to the K⁺ transport^{S21, resulting in a} 19% increase in the total volume of the capture solution, and secondly, as K₂CO₃ in the middle chamber was consumed and the solution became more acidic, protons began to crossover through the CEM instead of K⁺, neutralizing with OH⁻ in the capture solution. The latter contributed to a gradual decrease in the current efficiency of the electrocatalysis cell over time which reached 88.6±0.021%.

### CO₂ Release Analysis

In parallel with the regeneration of the capture solution in the HER chamber, the K₂CO₃ in the acidification chamber underwent gradual acidification (FIG. 5I) by the protons from the HOR chamber, converting to bicarbonate and finally to gaseous CO₂ (FIGS. 49D and 52). The experimental setup of the CO₂ release experiment is detailed in the “Product analysis” section of the Methods.

The released gas stream from the acidification compartment was assumed to consist of 97% CO₂ and 3% water vapor, behaving as an ideal gas at room temperature. The total amount of CO₂ released during experiments (n_{CO2}) is calculated as follows:

$${n}_{CO 2} = \frac{P \times {Q}_{CO 2} \times t}{R \times T}$$

P is the ambient pressure (101325 Pa), Q_{CO2} is the volumetric flow rate of CO₂, constituting 97% of the released steam, t is the total electrocatalysis operation time (s), R is the gas constant (8.31 J/K/mol), T is the electrocatalysis operation temperature (293K). The amount of CO₂ released was quantified using a standard curve provided in FIG. 54.

Comparison Between the Electrochemical DAC System in this Work and Previously Reported Systems

TABLE 1
Comparison between the electrochemical DAC system
in this work and previously reported systems

| | | Capture | Current | |
|---|---|---|---|---|
| | Captured form | solution | density | Energy costs |
| System | of CO₂ | pH | (mA/cm²) | (GJ/tCO₂) |
| Alkaline sorbent | Carbonate | 13 | 10 | 10.4 |
| regeneration^{S22} | | | | |
| BPMED*^{S23} | Carbonate | 11.6 | 8.6 | 10.5 |
| Alkaline sorbent | 46% | 13.1 | 2.5 | 8.5 |
| regeneration^{S24} | bicarbonate + | | | |
| | 54% carbonate | | | |
| Alkaline sorbent | 46% | 13 | 5 | 8.5 |
| regeneration^{S25} | bicarbonate + | | | |
| | 54% carbonate | | | |
| Alternating | Carbonate | 13 | 10-200 | 6.1-7.8 |
| electrocatalysis with | | | | |
| redox mediator^{S26} | | | | |
| Alternating | Carbonate | 13.3 | 10-120 | 3.8-8.5 |
| electrocatalysis with | | | | |
| redox mediator^{S27} | | | | |
| Porous solid-electrolyte | Carbonate | — | 0.5-3 | 4.5-6.8 |
| reactor^{S28} | | | | |
| Intercalation-based pH | Bicarbonate | 10 | 1 | 2.8 |
| swing^{S29} | | | | |
| Direct ocean capture | Bicarbonate | 8.2 | 3.3 | 3.5 |
| using BPMED*^{S30} | | | | |
| Neutral red organic | Neutral red- | — | 0.03 | 1.48 |
| PCET*^{S31} | induced pH | | | |
| | swing | | | |
| Pyridinium organic | Pyridinium- | — | <1 | 3.68 |
| PCET^{S32} | induced pH | | | |
| | swing | | | |
| This work | Carbonate | 14.55 | 10-300 | 3.3-9.2 |

*BPMED: Bipolar membrane electrodialysis; PCET: Proton-coupled electron transfer

### REFERENCES

Each of the below references is incorporated herein by reference in its entirety:
1 Net Zero by 2050—A Road map for the Global Energy Sector. (International Energy Agency, 2021).
2 Davis, S. J. et al. Net-zero emissions energy systems. Science 360, 6396-6404, doi:10.1126/science.aas9793 (2018).
3 Joppa, L. et al. Microsoft's million-tonne CO₂-removal purchase—lessons for net zero. Nature 597, 629-632 (2021).
4 Keith, D. W., Holmes, G., St. Angelo, D. & Heidel, K. A Process for Capturing CO₂ from the Atmosphere. Joule 2, 1573-1594, doi:10.1016/j.joule.2018.05.006 (2018).
5 Brethome, F. M., Williams, N. J., Seipp, C. A., Kidder, M. K. & Custelcean, R. Direct air capture of CO₂ via aqueous-phase absorption and crystalline-phase release using concentrated solar power. Nature Energy 3, 553-559, doi:10.1038/s41560-018-0150-z (2018).
6 Custelcean, R., Garrabrant, K. A., Agullo, P. & Williams, N. J. Direct air capture of CO2 with aqueous peptides and crystalline guanidines. Cell Reports Physical Science 2, 100385, doi:10.1016/j.xcrp.2021.100385 (2021).
7 Ozkan, M., Nayak, S. P., Ruiz, A. D. & Jiang, W. Current status and pillars of direct air capture technologies. iScience 25, 103990, doi:10.1016/j.isci.2022.103990 (2022).
8 Kuru, T., Khaleghi, K. & Livescu, S. Solid sorbent direct air capture using geothermal energy resources (S-DAC-GT)—Region specific analysis. Geoenergy Science and Engineering 224, 211645, doi:10.1016/j.geoen.2023.211645 (2023).
9 Wijesiri, R. P., Knowles, G. P., Yeasmin, H., Hoadley, A. F. A. & Chaffee, A. L. Technoeconomic Evaluation of a Process Capturing CO2 Directly from Air. Processes 7, 503, doi:10.3390/pr7080503 (2019).
10 Deutz, S. & Bardow, A. Life-cycle assessment of an industrial direct air capture process based on temperature-vacuum swing adsorption. Nature Energy 6, 203-213, doi:10.1038/s41560-020-00771-9 (2021).
11 Liu, S. et al. Direct air capture of CO2via cyclic viologen electrocatalysis. Energy & Environmental Science 17, 1266-1278, doi:10.1039/d3ee03024e (2024).
12 Xu, Y. et al. Regeneration of direct air CO₂ capture liquid via alternating electrocatalysis. Joule 7, 2107-2117, doi:10.1016/j.joule.2023.07.011 (2023).
13 Ramezani, R., Mazinani, S. & Di Felice, R. State-of-the-art of CO₂ capture with amino acid salt solutions. Rev. Chem. Eng. 38, 273-299, doi:10.1515/revce-2020-0012 (2022).
14 Kikkawa, S. et al. Direct Air Capture of CO(2) Using a Liquid Amine-Solid Carbamic Acid Phase-Separation System Using Diamines Bearing an Aminocyclohexyl Group. ACS environmental Au 2, 354-362, doi:10.1021/acsenvironau.1c00065 (2022).
15 Rabensteiner, M., Kinger, G., Koller, M. & Hochenauer, C. PCC pilot plant studies with aqueous potassium glycinate. International Journal of Greenhouse Gas Control 42, 562-570, doi:10.1016/j.ijggc.2015.09.012 (2015).
16 Holmes, G. & Keith, D. W. An air-liquid contactor for large-scale capture of CO₂ from air. Philosophical transactions. Series A, Mathematical, physical, and engineering sciences 370, 4380-4403, doi:10.1098/rsta.2012.0137 (2012).
17 Stolaroff, J. K., Keith, D. W. & Lowry, G. V. Carbon Dioxide Capture from Atmospheric Air Using Sodium Hydroxide Spray. Environmental science & technology 42, 2728-2735, doi:10.1021/es702607w (2008).
18 Pérez-Villaseñor, F., Iglesias-Silva, G. A. & Hall, K. R. Osmotic and Activity Coefficients Using a Modified Pitzer Equation for Strong Electrolytes 1:1 and 1:2 at 298.15 K. Industrial & Engineering Chemistry Research 41, 1031-1037, doi:10.1021/ie0103153 (2002).
19 Hausmann, J. N., Traynor, B., Myers, R. J., Driess, M. & Menezes, P. W. The pH of Aqueous NaOH/KOH Solutions: A Critical and Non-trivial Parameter for Electrocatalysis. ACS Energy Letters 6, 3567-3571, doi:10.1021/acsenergylett.1c01693 (2021).
20 Konno, H., Nanri, Y. & Kitamura, M. Crystallization of aragonite in the causticizing reaction. Powder Technol. 123, 33-39, doi:https://doi.org/10.1016/S0032-5910(01)00424-7 (2002).
21 Dunlap, P. M. & Faris, S. R. Surface Tension of Aqueous Solutions of Potassium Hydroxide. Nature 196, 1312-1313, doi:10.1038/1961312a0 (1962).
22 Shahidzadeh-Bonn, N., Rafai, S., Bonn, D. & Wegdam, G. Salt Crystallization during Evaporation: Impact of Interfacial Properties. Langmuir 24, 8599-8605, doi:10.1021/la8005629 (2008).
23 Salim, H., Kolpakov, P., Bonn, D. & Shahidzadeh, N. Self-Lifting NaCl Crystals. The Journal of Physical Chemistry Letters 11, 7388-7393, doi:10.1021/acs.jpclett.0c01871 (2020).
24 Qazi, M. J., Salim, H., Doorman, C. A. W., Jambon-Puillet, E. & Shahidzadeh, N. Salt creeping as a self-amplifying crystallization process. Science Advances 5, eaax1853, doi:doi:10.1126/sciadv.aax1853 (2019).
25 Chen, X. et al. Spatially separated crystallization for selective lithium extraction from saline water. Nature Water 1, 808-817, doi:10.1038/s44221-023-00131-3 (2023).
26 Bartl, A. Textiles production and end-of-life management options. 251-279, doi:10.1016/b978-0-12-817880-5.00010-4 (2020).
27 Rostami, R. et al. An investigation into influence of physical and chemical surface modification of macro-polypropylene fibers on properties of cementitious composites. Construction and Building Materials 244, 118340, doi:10.1016/j.conbuildmat.2020.118340 (2020).
28 Wardani, A. K., Ariono, D., Yespin, Y., Sihotang, D. R. & Wenten, I. G. Preparation of hydrophilic polypropylene membrane by acid dipping technique. Materials Research Express 6, 075308, doi:10.1088/2053-1591/ab10cf (2019).
29 Fávaro, S. L., Rubira, A. F., Muniz, E. C. & Radovanovic, E. Surface modification of HDPE, PP, and PET films with KMnO4/HCl solutions. Polym. Degrad. Stab. 92, 1219-1226, doi:10.1016/j.polymdegradstab.2007.04.005 (2007).
30 Wang, X. et al. Biomimetic Fibrous Murray Membranes with Ultrafast Water Transport and Evaporation for Smart Moisture-Wicking Fabrics. ACS Nano 13, 1060-1070, doi:10.1021/acsnano.8b08242 (2019).
31 Zeman, F. Experimental results for capturing CO2 from the atmosphere. AIChE J. 54, 1396-1399, doi:10.1002/aic.11452 (2008).
32 Mahmoudkhani, M., Heidel, K. R., Ferreira, J. C., Keith, D. W. & Cherry, R. S. Low energy packed tower and caustic recovery for direct capture of CO2 from air. Energy Procedia 1, 1535-1542, doi:10.1016/j.egypro.2009.01.201 (2009).
33 Baciocchi, R., Storti, G. & Mazzotti, M. Process design and energy requirements for the capture of carbon dioxide from air. Chemical Engineering and Processing: Process Intensification 45, 1047-1058, doi:10.1016/j.cep.2006.03.015 (2006).
34 Mersmann, A. & Löffelmann, M. Crystallization and Precipitation: The Optimal Supersaturation. Chemical Engineering & Technology 23, 11-15, doi:10.1002/(sici)1521-4125(200001)23:1<11::aid-ceatl 1>3.0.co;2-u (2000).
35 Spanos, N. & Koutsoukos, P. G. Kinetics of Precipitation of Calcium Carbonate in Alkaline pH at Constant Supersaturation. Spontaneous and Seeded Growth. The Journal of Physical Chemistry B 102, 6679-6684, doi:10.1021/jp981171h (1998).
36 Archer, C. L. & Jacobson, M. Z. Evaluation of global wind power. Journal of Geophysical Research: Atmospheres 110, doi:10.1029/2004jd005462 (2005).
37 Direct Air Capture—A key technology for net zero. (International Energy Agency, 2022).
38 Shu, Q., Legrand, L., Kuntke, P., Tedesco, M. & Hamelers, H. V. M. Electrochemical Regeneration of Spent Alkaline Absorbent from Direct Air Capture. Environmental science & technology 54, 8990-8998, doi:10.1021/acs.est.Oc01977 (2020).
39 Pang, S. et al. A phenazine-based high-capacity and high-stability electrochemical CO2 capture cell with coupled electricity storage. Nature Energy 8, 1126-1136, doi:10.1038/s41560-023-01347-z (2023).
40 Zhu, P. et al. Continuous carbon capture in an electrochemical solid-electrolyte reactor. Nature 618, 959-966, doi:10.1038/s41586-023-06060-1 (2023).
41 Agricultural production statistics. 2000-2021 (ISSN 2709-0078, Food and Agriculture Organization of the United Nations, 2022).
S1 Belmonte, G. K., Charles, G., Strumia, M. C. & Weibel, D. E. Permanent hydrophilic modification of polypropylene and poly(vinyl alcohol) films by vacuum ultraviolet radiation. Applied Surface Science 382, 93-100, doi:10.1016/j.apsusc.2016.04.091 (2016).
S2 Atsushi, K., Shin-ichi, K. & Hitoshi, K. Polymer Surface Treatment by Atmospheric Pressure Low Temperature Surface Discharge Plasma: Its Characteristics and Comparison with Low Pressure Oxygen Plasma Treatment. Plasma Science and Technology 9, 181, doi:10.1088/1009-0630/9/2/14 (2007).
S3 Fitaroni, L. B. et al. Polymeric nanowrinkles: surface modification of polypropylene films in the VUV energy range. Journal of Materials Science 56, 9532-9543, doi:10.1007/s10853-021-05879-1 (2021).
S4 Awaja, F. et al. Surface properties of polypropylene following a novel industrial surface-treatment process. Surface and Interface Analysis 40, 1454-1462, doi:10.1002/sia.2924 (2008).
S5 Keith, D. W., Holmes, G., St. Angelo, D. & Heidel, K. A Process for Capturing CO2 from the Atmosphere. Joule 2, 1573-1594, doi:10.1016/j.joule.2018.05.006 (2018).
S6 Holmes, G. & Keith, D. W. An air-liquid contactor for large-scale capture of CO2 from air. Philos Trans A Math Phys Eng Sci 370, 4380-4403, doi:10.1098/rsta.2012.0137 (2012).
S7 Zeman, F. Experimental results for capturing CO2 from the atmosphere. AIChE Journal 54, 1396-1399, doi:10.1002/aic.11452 (2008).
S8 Mahmoudkhani, M., Heidel, K. R., Ferreira, J. C., Keith, D. W. & Cherry, R. S. Low energy packed tower and caustic recovery for direct capture of CO2 from air. Energy Procedia 1, 1535-1542, doi:10.1016/j.egypro.2009.01.201 (2009).
S9 Baciocchi, R., Storti, G. & Mazzotti, M. Process design and energy requirements for the capture of carbon dioxide from air. Chemical Engineering and Processing: Process Intensification 45, 1047-1058, doi:10.1016/j.cep.2006.03.015 (2006).
S10 Hausmann, J. N., Traynor, B., Myers, R. J., Driess, M. & Menezes, P. W. The pH of Aqueous NaOH/KOH Solutions: A Critical and Non-trivial Parameter for Electrocatalysis. ACS Energy Letters 6, 3567-3571, doi:10.1021/acsenergylett.1c01693 (2021).
S11 Agricultural production statistics. 2000-2021 (ISSN 2709-0078, Food and Agriculture Organization of the United Nations, 2022).
S12 Chen, X. et al. Spatially separated crystallization for selective lithium extraction from saline water. Nature Water 1, 808-817, doi:10.1038/s44221-023-00131-3 (2023).
S13 Stolaroff, J. K., Keith, D. W. & Lowry, G. V. Carbon Dioxide Capture from Atmospheric Air Using Sodium Hydroxide Spray. Environ Sci Technol 42, 2728-2735, doi:10.1021/es702607w (2008).
S14 Duan, Z. & Sun, R. An improved model calculating CO2 solubility in pure water and aqueous NaCl solutions from 273 to 533 K and from 0 to 2000 bar. Chemical Geology 193, 257-271, doi:https://doi.org/10.1016/S0009-2541(02)00263-2 (2003).
S15 Hayduk, W. & Laudie, H. Prediction of diffusion coefficients for nonelectrolytes in dilute aqueous solutions. AIChE Journal 20, 611-615, doi:10.1002/aic.690200329 (2004).
S16 Guo, Y.-j., Xu, H.-b., Guo, F., Zheng, S.-I. & Zhang, Y. Density and viscosity of aqueous solution of K2CrO4/KOH mixed electrolytes. Transactions of Nonferrous Metals Society of China 20, s32-s36, doi:https://doi.org/10.1016/S1003-6326(10)60007-6 (2010).
S17 Kuznetsov, K. I., Skorodumov, S. V. & Granchenko, P. P. Measurements of the Dynamic Viscosity and Density of KOH Solutions at Atmospheric Pressure. High Temperature 58, 806-811, doi:10.1134/s0018151x20060127 (2021).
S18 Pérez-Villaseñor, F., Iglesias-Silva, G. A. & Hall, K. R. Osmotic and Activity Coefficients Using a Modified Pitzer Equation for Strong Electrolytes 1:1 and 1:2 at 298.15 K. Industrial & Engineering Chemistry Research 41, 1031-1037, doi:10.1021/ie0103153 (2002).
S19 Zeman, F. Energy and Material Balance of CO2 Capture from Ambient Air. Environ Sci Technol 41, 7558-7563, doi:10.1021/es070874m (2007).
S20 Dunlap, P. M. & Faris, S. R. Surface Tension of Aqueous Solutions of Potassium Hydroxide. Nature 196, 1312-1313, doi:10.1038/1961312a0 (1962).
S21 Xu, F. et al. Study of electro-osmotic drag coefficients in Nafion membrane in acid, sodium and potassium forms by electrophoresis NMR. Journal of Membrane Science 536, 116-122, doi:10.1016/j.memsci.2017.04.067 (2017).
S22 Stucki, S., Schuler, A. & Constantinescu, M. Coupled CO2 recovery from the atmosphere and water electrolysis: Feasibility of a new process for hydrogen storage. International Journal of Hydrogen Energy 20, 653-663, doi:https://doi.org/10.1016/0360-3199(95)00007-Z (1995).
S23 Eisaman, M. D. et al. CO2 extraction from seawater using bipolar membrane electrodialysis. Energy & Environmental Science 5, 7346, doi:10.1039/c2ee03393c (2012).
S24 Shu, Q., Legrand, L., Kuntke, P., Tedesco, M. & Hamelers, H. V. M. Electrochemical Regeneration of Spent Alkaline Absorbent from Direct Air Capture. Environ Sci Technol 54, 8990-8998, doi:10.1021/acs.est.Oc01977 (2020).
S25 Shu, Q., Haug, M., Tedesco, M., Kuntke, P. & Hamelers, H. V. M. Direct Air Capture Using Electrochemically Regenerated Anion Exchange Resins. Environ Sci Technol 56, 11559-11566, doi:10.1021/acs.est.2c01944 (2022).
S26 Xu, Y. et al. Regeneration of direct air CO2 capture liquid via alternating electrocatalysis. Joule 7, 2107-2117, doi:10.1016/j.joule.2023.07.011 (2023).
S27 Liu, S. et al. Direct air capture of CO2via cyclic viologen electrocatalysis. Energy & Environmental Science 17, 1266-1278, doi:10.1039/d3ee03024e (2024).
S28 Zhu, P. et al. Continuous carbon capture in an electrochemical solid-electrolyte reactor. Nature 618, 959-966, doi:10.1038/s41586-023-06060-1 (2023).
S29 Kim, S. et al. Asymmetric chloride-mediated electrochemical process for CO2 removal from oceanwater. Energy & Environmental Science 16, 2030-2044, doi:10.1039/d2ee03804h (2023).
S30 Digdaya, I. A. et al. A direct coupled electrochemical system for capture and conversion of CO(2) from oceanwater. Nature Communications 11, 4412, doi:10.1038/s41467-020-18232-y (2020).
S31 Seo, H. & Hatton, T. A. Electrochemical direct air capture of CO(2) using neutral red as reversible redox-active material. Nature Communications 14, 313, doi:10.1038/s41467-023-35866-w (2023).
S32 Seo, H., Rahimi, M. & Hatton, T. A. Electrochemical Carbon Dioxide Capture and Release with a Redox-Active Amine. Journal of the American Chemical Society 144, 2164-2170, doi:10.1021/jacs.1c10656 (2022).
S33 Mayyas, A., Ruth, M., Pivovar, B., Bender, G. & Wipke, K. Manufacturing Cost Analysis for Proton Exchange Membrane Water Electrolyzers (NREL/TP-6A20-72740, National Renewable Energy Laboratory, 2019).
S34 Socolow, R., Desmond, M., Aines, R., Blackstock, J., Bolland, O., Kaarsberg, T., Lewis, N., Mazzotti, M., Pfeffer, A., Sawyer, K., Siirola, J., Smit, B. & Wilcox, J. Direct Air Capture of CO2 with Chemicals: A Technology Assessment for the APS Panel on Public Affairs (American Physical Society, 2011).
S35 Moch, J. M., Xue, W. & Holdren, J. P. Carbon capture, utilization, and storage: Technologies and costs in the U.S. context (President and Fellows of Harvard College, 2022).
S36 Kearns, D., Liu, H. & Consoli, C. Technology Readiness and Costs for CCS (Global CCS Institute, 2021).

What is claimed is:

1. A method of forming a precipitate, the method comprising:
providing one or more polymeric strands in contact with an alkaline capture solution, each of the polymeric strands comprised of a plurality of polymeric fibers that combine to form an outer surface of the polymeric strand, the outer surface of the strand forming a crystallizing surface, the alkaline capture solution travelling by way of capillary force from the outer surface of the strand inwardly and from a first end of the strand in a direction towards a second end of the strand through intra-strand pores, water within the alkaline solution evaporating from the alkaline solution as the alkaline solution travels from the first end towards the second end; and
as the alkaline solution travels towards the second end, contacting the one or more polymeric strands with ambient air, KOH within the alkaline solution reacting with CO₂ in the ambient air at the crystallizing surface to form K₂CO₃ precipitate at the crystallizing surface.

2. The method of claim 1, wherein the one or more polymeric strands are formed of a polymer selected from the group comprising: polypropylene, polyethylene, polyvinyl chloride, polystyrene, polyethylene terephthalate, polyamide, polycarbonate, polyurethane, acrylonitrile butadiene styrene, polymethyl methacrylate, polyoxymethylene, and polybutylene terephthalate.

3. The method of claim 2, wherein the one or more polymeric strands comprise polypropylene.

4. The method of claim 1, wherein the polymeric fibers are parallel with each other within the strand.

5. The method of claim 1, wherein providing one or more polymeric strands includes providing one or more polymeric cords, each polymeric cord comprising two or more polymeric strands.

6. The method of claim 1, wherein the one or more polymeric strands each of have an ascending portion and a descending portion, the alkaline capture solution travelling upwardly along the ascending portion by way of the capillary force and downwardly along the descending portion by gravity.

7. The method of claim 6, wherein the K₂CO₃ precipitate forms at the crystallizing surface along the descending portion.

8. The method of claim 6, wherein the water within the alkaline capture solution evaporating from the strand occurs as the alkaline capture solution travels downwardly along the descending portion.

9. The method of claim 3, wherein the polypropylene is chemically modified by at least one of hydrophilization, corona discharge, or plasma treatment.

10. A method of direct air capture of carbon dioxide, the method comprising:
providing one or more polymeric strands in contact with an alkaline capture solution, each of the polymeric strands comprised of a plurality of polymeric fibers that combine to form an outer surface of the polymeric strand, the outer surface of the strand forming a crystallizing surface;
positioning at least a portion of the strands into an alkaline capture solution, the alkaline capture solution travelling by way of capillary force from the outer surface of the strand inwardly and from a first end of the strand in a direction towards a second end of the strand through intra-strand pores, water within the alkaline solution evaporating from the alkaline solution as the alkaline solution travels from the first end towards the second end;
as the alkaline solution travels towards the second end, contacting the one or more polymeric strands with ambient air, KOH within the alkaline solution reacting with CO₂ in the ambient air at the crystallizing surface to form K₂CO₃ precipitate at the crystallizing surface;
flooding the strands with a flooding fluid to wash the K₂CO₃ precipitate from the crystallizing surface;
collecting the washed K₂CO₃ precipitate; and
introducing the washed K₂CO₃ precipitate into an electrochemical cell to produce carbon dioxide and KOH.

11. A crystallizer device comprising:
a solution platform housing an alkaline capture solution; and
a plurality of polymeric strands in contact with the alkaline capture solution, each of the polymeric strands having:
a plurality of polymeric fibers that combine to form an outer surface of the polymeric strand, the outer surface of the strand forming a crystallizing surface, the alkaline capture solution travelling by way of capillary action from the outer surface of the strand inwardly and from a first end of the strand in a direction towards a second end of the strand through intra-strand pores, water within the alkaline solution evaporating from the alkaline solution as the alkaline solution travels from the first end towards the second end.

12. The device of claim 11, wherein the one or more polymeric strands are formed of a polymer selected from the group comprising: polypropylene, polyethylene, polyvinyl chloride, polystyrene, polyethylene terephthalate, polyamide, polycarbonate, polyurethane, acrylonitrile butadiene styrene, polymethyl methacrylate, polyoxymethylene, and polybutylene terephthalate.

13. The device of claim 12, wherein the one or more polymeric strands comprise polypropylene.

14. The device of claim 11, wherein the polymeric fibers are parallel with each other within the strand.

15. The device of claim 11, wherein providing one or more polymeric strands includes providing one or more polymeric cords, each polymeric cord comprising two or more polymeric strands woven together.

16. The device of claim 11, wherein the one or more polymeric strands each of an ascending portion and a descending portion, the alkaline capture solution travelling upwardly along the ascending portion by way of capillary action and downwardly along the descending portion by gravity.

17. The device of claim 16, wherein the K₂CO₃ precipitate forms at the crystallizing surface along the descending portion.

18. The device of claim 16, wherein the water within the alkaline capture solution evaporating from the strand occurs as the alkaline capture solution travels downwardly along the descending portion.

19. The device of claim 18, wherein the polypropylene is chemically modified by at least one of hydrophilization, corona discharge, or plasma treatment.

20. The device of claim 11 further comprising a sensor gauge configured to monitor a height of the alkaline capture solution in the solution platform and a pump communicatively coupled to the sensor gauge, the pump being configured to provide additional alkaline capture solution to the platform upon receiving a signal from the sensor gauge that the height of the alkaline capture solution is below a threshold height.
